(19) United States
(12) Patent Application Publication
(10) Pub. No.: US 2016/0224241 A1
(43) Pub. Date: Aug. 4, 2016

(54) PROVIDING MEMORY BANDWIDTH COMPRESSION USING BACK-TO-BACK READ OPERATIONS BY COMPRESSED MEMORY CONTROLLERS (CMCs) IN A CENTRAL PROCESSING UNIT (CPU)-BASED SYSTEM

(71) Applicant: QUALCOMM Incorporated, San Diego, CA (US)

(72) Inventors: Colin Beaton Verrilli, Apex, NC (US); Mattheus Cornelis Antonius Adrianus Heddes, Raleigh, NC (US); Brian Joel Schuh, Apex, NC (US); Michael Raymond Trombley, Cary, NC (US); Natarajan Vaidhyanathan, Carrboro, NC (US)

(21) Appl. No.: 14/844,516

(22) Filed: Sep. 3, 2015

Related U.S. Application Data
(60) Provisional application No. 62/111,347, filed on Feb. 3, 2015.

(51) Int. Cl. G06F 3/06

(52) U.S. Cl. CPC G06F 3/061; G06F 3/0659; G06F 3/0661; G06F 3/0679

(57) ABSTRACT

Providing memory bandwidth compression using back-to-back read operations by compressed memory controllers (CMCs) in a central processing unit (CPU)-based system is disclosed. In this regard, in some aspects, a CMC is configured to receive a memory read request to a physical address in a system memory, and read a compression indicator (CI) for the physical address from error correcting code (ECC) bits of a first memory block in a memory line associated with the physical address. Based on the CI, the CMC determines whether the first memory block comprises compressed data. If not, the CMC performs a back-to-back read of one or more additional memory blocks of the memory line in parallel with returning the first memory block. Some aspects may further improve memory access latency by writing compressed data to each of a plurality of memory blocks of the memory line, rather than only to the first memory block.

### PRIORITY APPLICATION

The present application claims priority to U.S. Provisional Patent Application Ser. No. 62/111,347 filed on Feb. 3, 2015 and entitled “MEMORY CONTROLLERS EMPLOYING MEMORY BANDWIDTH COMPRESSION EMPLOYING BACK-TO-BACK READ OPERATIONS FOR IMPROVED LATENCY, AND RELATED PROCESSOR-BASED SYSTEMS AND METHODS,” which is incorporated herein by reference in its entirety.

### BACKGROUND

I. Field of the Disclosure

The technology of the disclosure relates generally to computer memory systems, and particularly to memory controllers in computer memory systems for providing central processing units (CPUs) with a memory access interface to memory.

II. Background

Microprocessors perform computational tasks in a wide variety of applications. A typical microprocessor application includes one or more central processing units (CPUs) that execute software instructions. The software instructions may instruct a CPU to fetch data from a location in memory, perform one or more CPU operations using the fetched data, and generate a result. The result may then be stored in memory. As non-limiting examples, this memory can be a cache local to the CPU, a shared local cache among CPUs in a CPU block, a shared cache among multiple CPU blocks, or main memory of the microprocessor.

In this regard, FIG. 1 is a schematic diagram of an exemplary system-on-a-chip (SoC) 10 that includes a CPU-based system 12. The CPU-based system 12 includes a plurality of CPU blocks 14(1)-14(N) in this example, wherein ‘N’ is equal to any number of CPU blocks 14(1)-14(N) desired. In the example of FIG. 1, each of the CPU blocks 14(1)-14(N) contains two CPUs 16(1), 16(2). The CPU blocks 14(1)-14(N) further contain shared Level 2 (L2) caches 18(1)-18(N), respectively. A shared Level 3 (L3) cache 20 is also provided for storing cached data that is used by any of, or shared among, each of the CPU blocks 14(1)-14(N). An internal system bus 22 is provided to enable each of the CPU blocks 14(1)-14(N) to access the shared L3 cache 20 as well as other shared resources. Other shared resources accessed by the CPU blocks 14(1)-14(N) through the internal system bus 22 may include a memory controller 24 for accessing a main, external memory (e.g., double-rate dynamic random access memory (DRAM) (DDR), as a non-limiting example), peripherals 26, other storage 28, an express peripheral component interconnect (PCI) (PCI-e) interface 30, a direct memory access (DMA) controller 32, and/or an integrated memory controller (IMC) 34.

As CPU-based applications executing in the CPU-based system 12 in FIG. 1 increase in complexity and performance, the memory capacity requirements of the shared L2 caches 18(1)-18(N) and the shared L3 cache 20, and external memory accessible through the memory controller 24 may also increase. Data compression may be employed to increase the effective memory capacity of the CPU-based system 12 without increasing physical memory capacity. However, the use of data compression may increase memory access latency and consume additional memory bandwidth, as multiple memory access requests may be required to retrieve data, depending on whether the data is compressed or uncompressed. Accordingly, it is desirable to increase memory capacity of the CPU-based system 12 using data compression while mitigating the impact on memory access latency and memory bandwidth.

### SUMMARY OF THE DISCLOSURE

Aspects disclosed herein include providing memory bandwidth compression using back-to-back read operations by compressed memory controllers (CMCs) in a central processing unit (CPU)-based system. In this regard, in some aspects, a CMC is configured to provide memory bandwidth compression for memory read requests and/or memory write requests. According to some aspects, upon receiving a memory read request to a physical address in a system memory, the CMC may read a compression indicator (CI) for the physical address from error correcting code (ECC) bits of a first memory block in a memory line associated with the physical address in the system memory. Based on the CI, the CMC determines whether the first memory block comprises compressed data. If the first memory block does not comprise compressed data, the CMC may improve memory access latency by performing a back-to-back read of one or more additional memory blocks of the memory line in parallel with returning the first memory block (if the first memory block comprises a demand word). In some aspects, the memory block read by the CMC may be a memory block containing the demand word as indicated by a demand word indicator of the memory read request. Some aspects may provide further memory access latency improvement by writing compressed data to each of a plurality of memory blocks of the memory line, rather than only to the first memory block. In such aspects, the CMC may read a memory block indicated by the demand word indicator, and be assured that the read memory block (whether it contains compressed data or uncompressed data) will provide the demand word. In this manner, the CMC may read and write compressed and uncompressed data more efficiently, resulting in decreased memory access latency and improved system performance.

In another aspect, a CMC is provided, comprising a memory interface configured to access a system memory via a system bus. The CMC is configured to receive a memory read request comprising a physical address of a first memory line comprising a plurality of memory blocks in the system memory. The CMC is further configured to read a first memory block of the plurality of memory blocks of the first memory line. The CMC is also configured to determine, based on a CI of the first memory block, whether the first memory block comprises compressed data. The CMC is additionally configured to, responsive to determining that the first memory block does not comprise the compressed data, perform a back-to-back read of one or more additional memory blocks of the plurality of memory blocks of the first memory line. The CMC is further configured to, in parallel with the back-to-back read, determine whether a read memory block comprises a demand word, and responsive to determining that the read memory block comprises the demand word, return the read memory block.

In another aspect, a CMC is provided, comprising a memory interface configured to access a system memory via a system bus. The CMC is configured to receive a memory read request comprising a physical address of a first memory line comprising a plurality of memory blocks in the system memory, and a demand word indicator indicating a memory block among the plurality of memory blocks of the first memory line containing a demand word. The CMC is further configured to read the memory block indicated by the demand word indicator. The CMC is also configured to determine, based on a CI of the memory block, whether the memory block comprises compressed data. The CMC is additionally configured to, responsive to determining that the memory block does not comprise the compressed data, perform a back-to-back read of one or more additional memory blocks of the plurality of memory blocks of the first memory line in parallel with returning the memory block.

In another aspect, a method for providing memory bandwidth compression is provided. The method comprises receiving a memory read request comprising a physical address of a first memory line comprising a plurality of memory blocks in a system memory. The method further comprises reading a first memory block of the plurality of memory blocks of the first memory line. The method also comprises determining, based on a CI of the first memory block, whether the first memory block comprises compressed data. The method additionally comprises, responsive to determining that the first memory block does not comprise the compressed data, performing a back-to-back read of one or more additional memory blocks of the plurality of memory blocks of the first memory line. The method further comprises, in parallel with the back-to-back read, determining whether a read memory block comprises a demand word, and responsive to determining that the read memory block comprises the demand word, returning the read memory block.

In another aspect, a method for providing memory bandwidth compression is provided. The method comprises receiving a memory read request comprising a physical address of a first memory line comprising a plurality of memory blocks in a system memory, and a demand word indicator indicating a memory block among the plurality of memory blocks of the first memory line containing a demand word. The method further comprises reading the memory block indicated by the demand word indicator. The method also comprises determining, based on a CI of the memory block, whether the memory block comprises compressed data. The method additionally comprises, responsive to determining that the memory block does not comprise the compressed data, performing a back-to-back read of one or more additional memory blocks of the plurality of memory blocks of the first memory line in parallel with returning the memory block.

In other aspects, compression methods and formats that may be well-suited for small data block compression are disclosed. These compression methods and formats can be employed for memory bandwidth compression aspects disclosed herein.

With some or all aspects of these CMCs and compression mechanisms, it may be possible to decrease memory access latency and effectively increase memory bandwidth of a CPU-based system, while mitigating an increase in physical memory size and minimizing the impact on system performance.

### BRIEF DESCRIPTION OF THE FIGURES

FIG. 1 is a schematic diagram of an exemplary system-on-a-chip (SoC) that includes a central processing unit (CPU)-based system;

FIG. 2 is a schematic diagram of an SoC that includes an exemplary CPU-based system having a plurality of CPUs and a compressed memory controller (CMC) configured to provide memory bandwidth compression;

FIG. 3 is a more detailed schematic diagram of the CMC of FIG. 2, wherein the CMC is further communicatively coupled to an optional, internal memory that may be employed to provide memory bandwidth compression;

FIG. 4 is a schematic diagram of an exemplary memory bandwidth compression mechanism that may be implemented by the CMC of FIG. 3;

FIG. 5 illustrates an example of the SoC of FIG. 1 that includes an optional Level 4 (L4) cache to compensate for performance loss due to address translation in a CMC;

FIGS. 6A and 6B are diagrams illustrating exemplary communications flows during memory read operations and memory write operations, respectively, and exemplary elements of a system memory that may be accessed by the CMC of FIG. 3 for providing memory bandwidth compression using back-to-back reads, early returns, and/or multiple compressed data writes;

FIGS. 7A-7C are flowcharts illustrating exemplary operations of the CMC of FIG. 3 for performing read operations in providing memory bandwidth compression using back-to-back reads and early returns;

FIG. 8 is a flowchart illustrating exemplary operations of the CMC of FIG. 3 for performing write operations in providing memory bandwidth compression using back-to-back reads and early returns;

FIGS. 9A-9C are flowcharts illustrating exemplary operations of the CMC of FIG. 3 for performing read operations in providing memory bandwidth compression using back-to-back reads and multiple compressed data writes;

FIG. 10 is a flowchart illustrating exemplary operations of the CMC of FIG. 3 for performing write operations in providing memory bandwidth compression using back-to-back reads and multiple compressed data writes;

FIGS. 11-17 illustrate exemplary data block compression formats and mechanisms, any of which may be used by the CMC of FIG. 3 to compress and decompress memory blocks; and

FIG. 18 is a block diagram of an exemplary computing device that may include the SoC of FIG. 1 that employs the CMC of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include providing memory bandwidth compression using back-to-back read operations by compressed memory controllers (CMCs) in a central processing unit (CPU)-based system. In this regard, in some aspects, a CMC is configured to provide memory bandwidth compression for memory read requests and/or memory write requests. According to some aspects, upon receiving a memory read request to a physical address in a system memory, the CMC may read a compression indicator (CI) for the physical address from error correcting code (ECC) bits of a first memory block in a memory line associated with the physical address in the system memory. Based on the CI, the CMC determines whether the first memory block comprises compressed data. If the first memory block does not comprise compressed data, the CMC may improve memory access latency by performing a back-to-back read of one or more additional memory blocks of the memory line in parallel with returning the first memory block (if the first memory block comprises a demand word). In some aspects, the memory block read by the CMC may be a memory block containing the demand word as indicated by a demand word indicator of the memory read request. Some aspects may provide further memory access latency improvement by writing compressed data to each of a plurality of memory blocks of the memory line, rather than only to the first memory block. In such aspects, the CMC may read a memory block indicated by the demand word indicator, and be assured that the read memory block (whether it contains compressed data or uncompressed data) will provide the demand word. In this manner, the CMC may read and write compressed and uncompressed data more efficiently, resulting in decreased memory access latency and improved system performance.

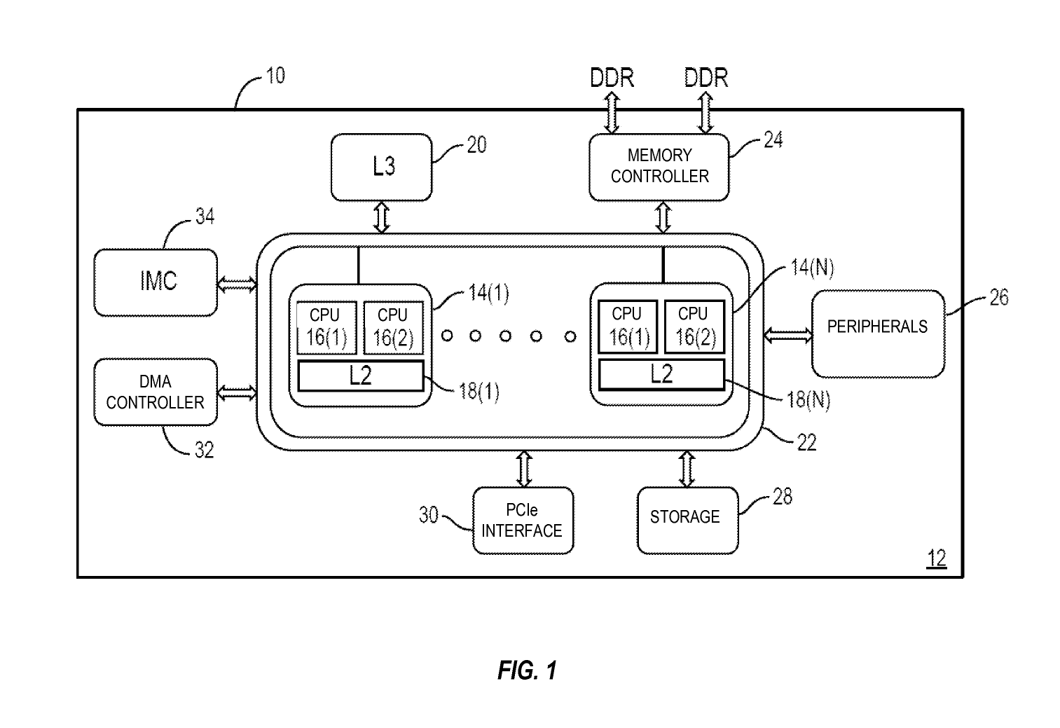

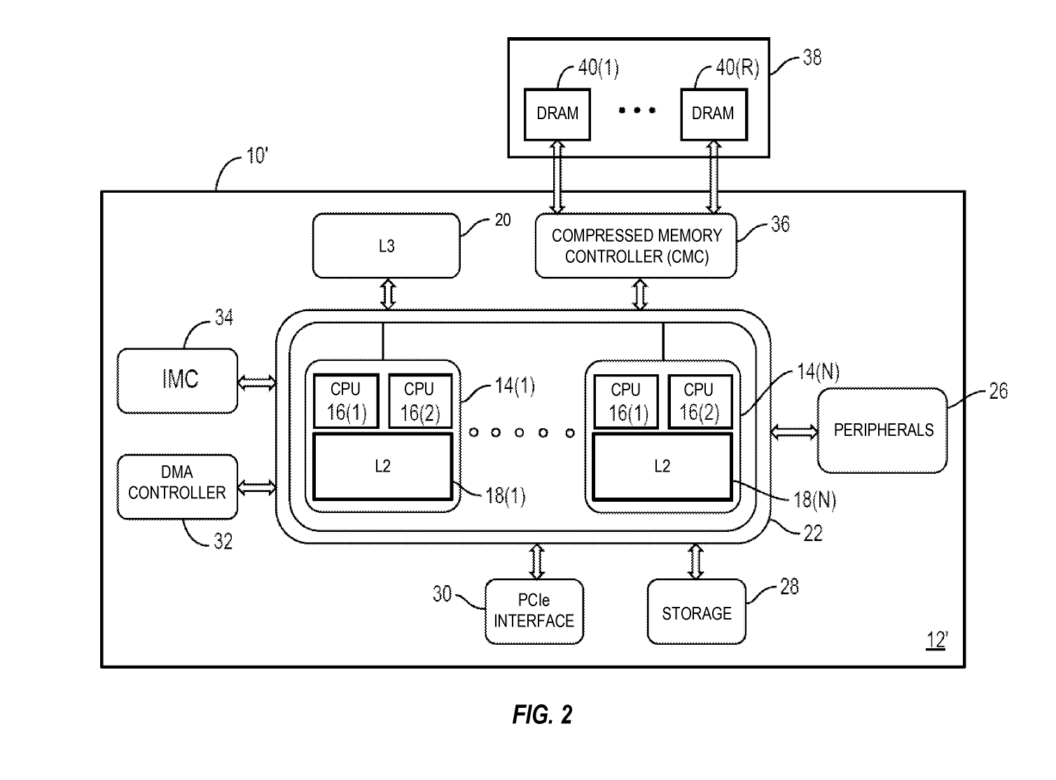

In this regard, FIG. 2 is a schematic diagram of an SoC 10′ that includes an exemplary CPU-based system 12′ having a plurality of CPU blocks 14(1)-14(N) similar to the CPU-based system 12 in FIG. 1. The CPU-based system 12′ in FIG. 2 includes some common components with the CPU-based system 12 in FIG. 1, which are noted by common element numbers between FIGS. 1 and 2. For the sake of brevity, these elements will not be re-described. However, in the CPU-based system 12′ in FIG. 2, a CMC 36 is provided. The CMC 36 controls access to a system memory 38. The system memory 38 may comprise one or more double data rate (DDR) dynamic random access memories (DRAMs) 40(1)-40(R) (referred to hereinafter as “DRAM 40(1)-40(R)”), as a non-limiting example. The CMC 36 in this example employs memory bandwidth compression according to the aspects disclosed herein and below. Similar to the memory controller 24 of the CPU-based system 12 of FIG. 1, the CMC 36 in the CPU-based system 12′ in FIG. 2 is shared by the CPU blocks 14(1)-14(N) through the internal system bus 22.

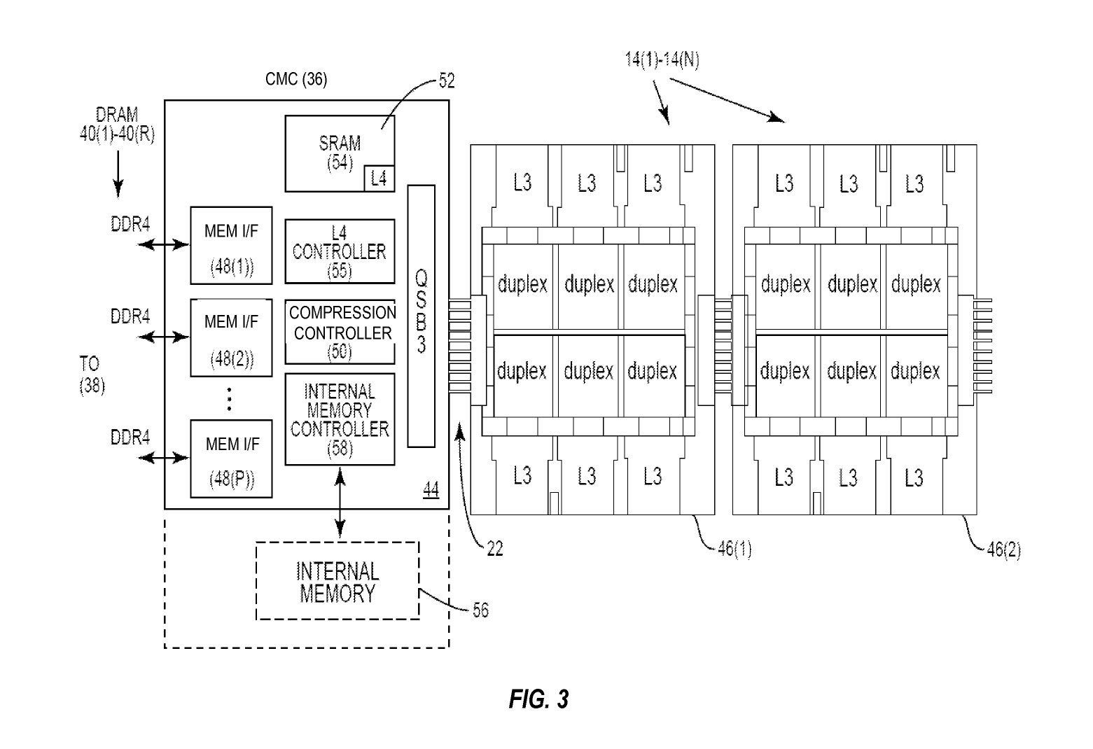

To illustrate a more detailed schematic diagram of exemplary internal components of the CMC 36 in FIG. 2, FIG. 3 is provided. In this example, the CMC 36 is provided on a separate semiconductor die 44 from semiconductor dies 46(1), 46(2) that contain the CPU blocks 14(1)-14(N) in FIG. 2. Alternatively, in some aspects the CMC 36 may be included in a common semiconductor die (not shown) with the CPU blocks 14(1)-14(N). Regardless of the die configurations, the CMC 36 is provided such that the CPU blocks 14(1)-14(N) may make memory access requests via the internal system bus 22 to the CMC 36, and receive data from memory through the CMC 36.

With continuing reference to FIG. 3, the CMC 36 controls operations for memory accesses to the system memory 38, which is shown in FIGS. 2 and 3 as comprising DRAM 40(1)-40(R). The CMC 36 includes a plurality of memory interfaces (MEM I/Fs) 48(1)-48(P) (e.g., DDR DRAM interfaces) used to service memory access requests (not shown). In this regard, the CMC 36 in this example includes a compression controller 50. The compression controller 50 controls compressing data stored to the system memory 38 and decompressing data retrieved from the system memory 38 in response to memory access requests from the CPU blocks 14(1)-14(N) in FIG. 2. In this manner, the CPU blocks 14(1)-14(N) can be provided with a virtual memory address space greater than the actual capacity of memory accessed by the CMC 36. The compression controller 50 can also be configured to perform bandwidth compression of information provided over the internal system bus 22 to the CPU blocks 14(1)-14(N).

As will be discussed in more detail below, the compression controller 50 can perform any number of compression techniques and algorithms to provide memory bandwidth compression. A local memory 52 is provided for data structures and other information needed by the compression controller 50 to perform such compression techniques and algorithms. In this regard, the local memory 52 is provided in the form of a static random access memory (SRAM) 54. The local memory 52 is of sufficient size to be used for data structures and other data storage that may be needed for the compression controller 50 to perform compression techniques and algorithms. The local memory 52 may also be partitioned to contain a cache, such as a Level 4 (L4) cache, to provide additional cache memory for internal use within the CMC 36. Thus, an L4 controller 55 may also be provided in the CMC 36 to provide access to the L4 cache. Enhanced compression techniques and algorithms may require a larger internal memory, as will be discussed in more detail below. For example, the local memory 52 may provide 128 kilobytes (kB) of memory.

Further, as shown in FIG. 3 and as will be described in more detail below, an optional additional internal memory 56 can also be provided for the CMC 36. The additional internal memory 56 may be provided as DRAM, as an example. As will be discussed in more detail below, the additional internal memory 56 can facilitate additional or greater amounts of storage of data structures and other data than in the local memory 52 for the CMC 36 providing memory compression and decompression mechanisms to increase the memory bandwidth compression of the CPU-based system 12′. An internal memory controller 58 is provided in the CMC 36 to control memory accesses to the additional internal memory 56 for use in compression. The internal memory controller 58 is not accessible or viewable to the CPU blocks 14(1)-14(N).

As noted above, the CMC 36 in FIG. 3 may perform memory bandwidth compression, including, in some aspects, zero-line compression. The local memory 52 can be used to store larger data structures used for such compression. As discussed in greater detail below, memory bandwidth compression may reduce memory access latency and allow more CPUs 16(1), 16(2) or their respective threads to access a same number of memory channels while minimizing the impact to memory access latency. In some aspects, the number of memory channels may be reduced while achieving similar latency results compared to a greater number of memory channels if such compression was not performed by the CMC 36, which may result in reduced system level power consumption.

Each of the resources provided for memory bandwidth compression in the CMC 36 in FIG. 3, including the local memory 52 and the additional internal memory 56, can be used individually or in conjunction with each other to achieve the desired balance among resources and area, power consumption, increased memory capacity through memory capacity compression, and increased performance through memory bandwidth compression. Memory bandwidth compression can be enabled or disabled, as desired. Further, the resources described above for use by the CMC 36 can be enabled or disabled to achieve the desired tradeoffs among memory capacity and/or bandwidth compression efficiency, power consumption, and performance. Exemplary memory bandwidth compression techniques using these resources available to the CMC 36 will now be discussed.

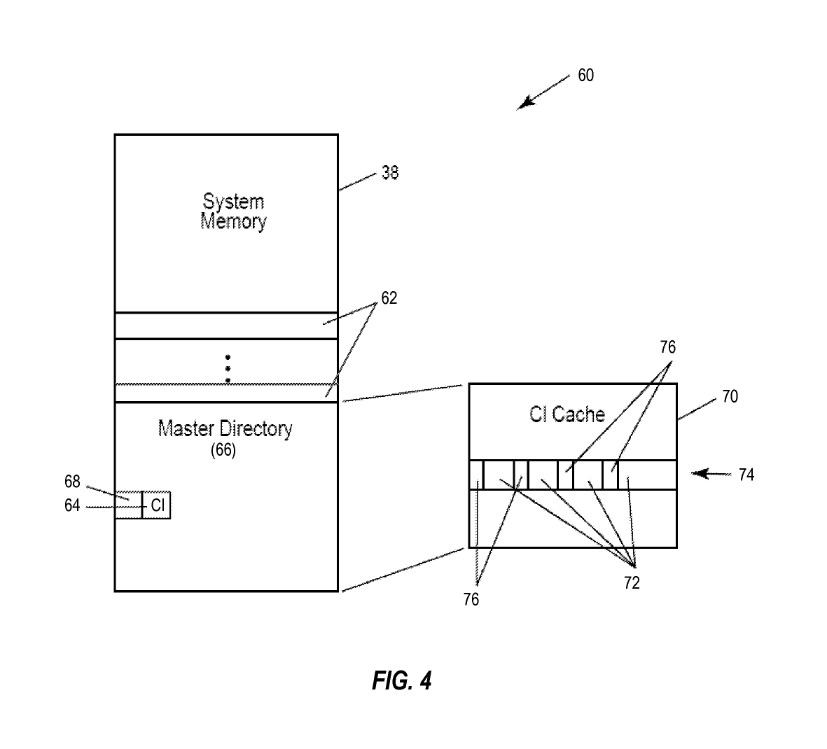

In this regard, FIG. 4 is a schematic diagram of an exemplary memory bandwidth compression mechanism 60 that can be implemented by the CMC 36 of FIG. 3 to provide memory bandwidth compression. In the memory bandwidth compression mechanism 60 of FIG. 4, the system memory 38 comprises a plurality of memory lines 62, each of which is associated with a physical address. Each of the plurality of memory lines 62 may be accessed by the CMC 36 using a physical address of a memory read or write request (not shown). Data (not shown) may be stored within each of the memory lines 62 in the system memory 38 in either compressed or uncompressed form. In some aspects, one or more error correcting code (ECC) bits comprising a CI 64 may be stored in association with each memory line 62 to indicate whether the memory line 62 is stored in compressed form or not. In this manner, when performing a memory access request to the system memory 38, the CMC 36 can check the CI 64 associated with the memory line 62 corresponding to the physical address to be addressed to determine if the memory line 62 is compressed as part of processing of the memory access request.

A master directory 66 is also provided in the system memory 38. The master directory 66 contains one entry 68 per memory line 62 in the system memory 38 corresponding to the physical address. The master directory 66 also contains one (1) CI 64 per entry 68 to denote if the memory line 62 is stored in compressed form, and if so, a compression pattern indicating a compression length of data is provided, in aspects in which multiple compression lengths are supported. For example, if the memory line 62 is 128 bytes in length and the data stored therein can be compressed to 64 bytes or less, the CI 64 in the master directory 66 corresponding to the data stored in the system memory 38 may be set to indicate that the data is stored in the first 64 bytes of the 128 byte memory line 62.

With continuing reference to FIG. 4, during a write operation, the CMC 36 can compress a memory block to be written into the system memory 38. For example, data (e.g., 128 bytes, or 256 bytes) is compressed. If the compressed memory block is smaller than or equal to the memory block size of the system memory 38 (e.g., 64 bytes), then 64 bytes can be written, otherwise 128 bytes are written. 256 bytes could be written as 64, 128, 192, or 256 bytes, depending on the compressed data size. The CI 64 stored in the one or more ECC bits associated with the memory line 62 in the system memory 38 can also be set to denote if the data at the memory line 62 is compressed or not.

During a read operation for example, the CMC 36 can read the CI 64 from the master directory 66 to determine whether the data to be read was compressed in the system memory 38. Based on the CI 64, the CMC 36 can read the data to be accessed from the system memory 38. If the data to be read was compressed in the system memory 38 as indicated by the CI 64, the CMC 36 can read the entire compressed memory block with one memory read operation. If the portion of data read was not compressed in the system memory 38, memory access latency may be negatively impacted because the additional portions of the memory line 62 to be read must also be read from the system memory 38. In some aspects, a training mechanism may be employed, for a number of address ranges, in which the CMC 36 may be configured to “learn” whether it is better to read the data in two accesses from the system memory 38 in a given set of circumstances, or whether it is better to read the full amount of data from the system memory 38 to avoid the latency impact.

In the example of FIG. 4, a CI cache 70 may also be provided in a separate cache outside of the system memory 38. The CI cache 70 provides one cache entry 72 per memory line 62 in the system memory 38 to denote if a memory line 62 in the system memory 38 is stored in compressed form or not. In this manner, when performing a memory access request to the system memory 38, the CMC 36 can first check the cache entry 72 in the CI cache 70 corresponding to the physical address to be addressed to determine if the memory line 62 at the physical address in the system memory 38 is compressed as part of processing of the memory access request without having to read the memory line 62. Thus, if the CI cache 70 indicates that the memory line 62 is stored compressed, the CMC 36 does not have to read out the entire memory line 62, thus reducing latency. If the CI cache 70 indicates that the memory line 62 is stored uncompressed, the CMC 36 can read out the entire memory line 62. If a miss occurs in the CI cache 70, the corresponding CI 64 stored in the master directory 66 can be consulted and loaded into the CI cache 70 for subsequent memory access requests to the same physical address.

In some aspects, the CI cache 70 may be organized as a conventional cache. The CI cache 70 may contain a tag array (not shown) and may be organized as an n-way associative cache, as a non-limiting example. The CMC 36 may implement an eviction policy with respect to the CI cache 70. In the CI cache 70 shown in FIG. 4, each cache line 74 may store multiple cache entries 72. Each cache entry 72 may contain a CI 76 to indicate if the memory line 62 in the system memory 38 associated with the cache entry 72 is compressed, and/or to represent a compression pattern indicating a compression size of the data corresponding to the cache entry 72. For example, the CI 76 may comprise two (2) bits representing four (4) potential compression sizes (e.g., 32, 64, 96, or 128 bytes). Note that in this example, the CI 64 is redundant, because this information is also stored in the CI 76 in the cache entries 72. For example, if the memory line 62 is 128 bytes in length and the data stored therein can be compressed to 64 bytes or less, the CI 76 in the cache entry 72 in the CI cache 70 corresponding to the memory line 62 in the system memory 38 may be set to indicate that the data is stored in the first 64 bytes of a 128 byte memory line 62.

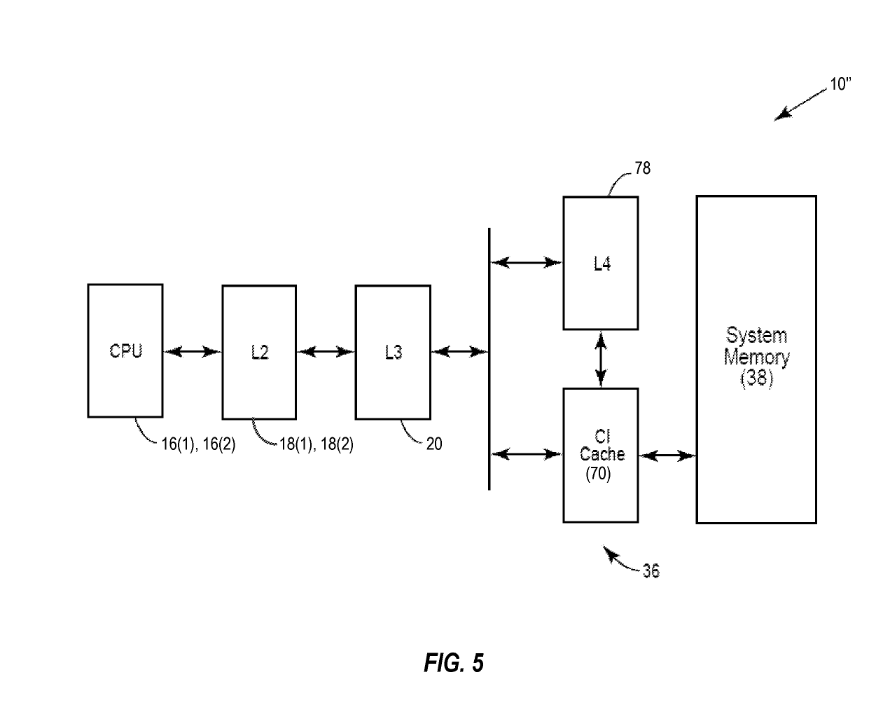

It may also be desired to provide an additional cache for the memory bandwidth compression mechanism 60 in FIG. 4. In this regard, FIG. 5 illustrates an example of an alternative SoC 10″ like the SoC 10′ in FIG. 2. However, the SoC 10″ in FIG. 5 additionally includes an optional cache 78, which is an L4 cache in this example. The CMC 36 can look up a physical address in both the L4 cache 78 and the CI cache 70 concurrently to minimize latency. The addresses in the L4 cache 78 are physical addresses that are uncompressed. Upon a physical address hit in the L4 cache 78, the physical address lookup in the CI cache 70 is redundant. Upon a physical address miss in the L4 cache 78, a physical address lookup in the CI cache 70 is required to obtain the data from the system memory 38. Also, to avoid additional latency of a CPU 16(1), 16(2) accessing both the L4 cache 78 and the CI cache 70, the L4 cache 78 and the CI cache 70 may be primed.

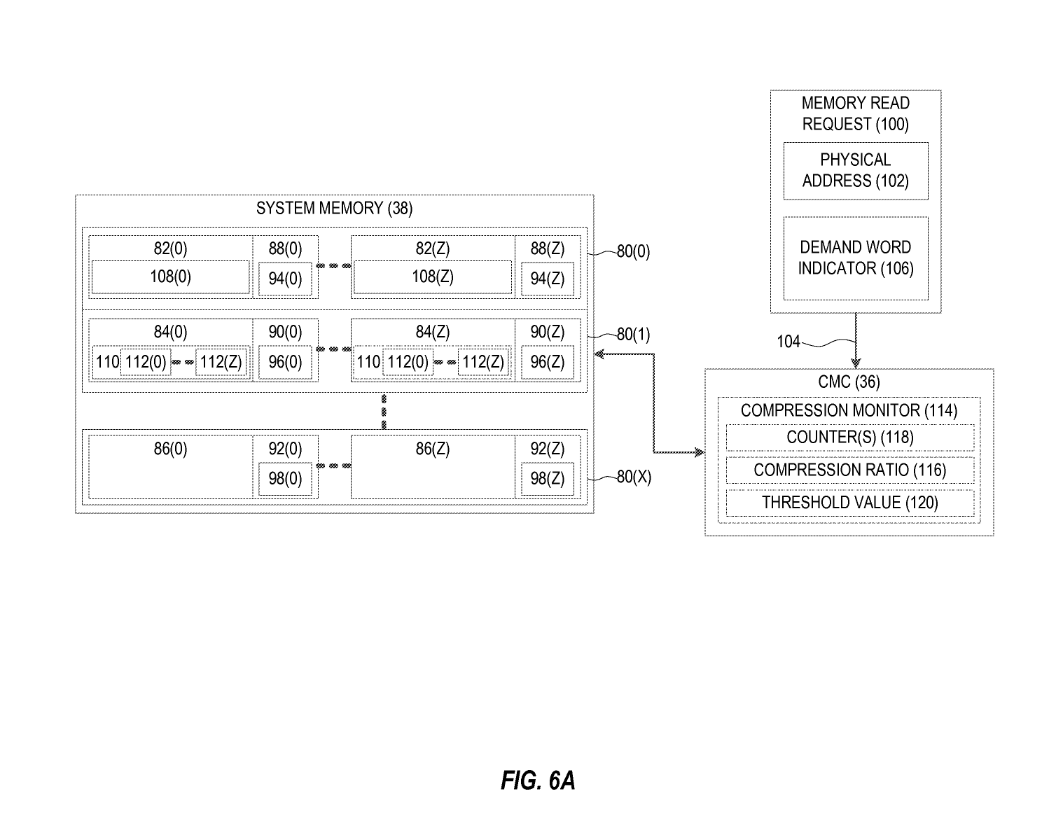

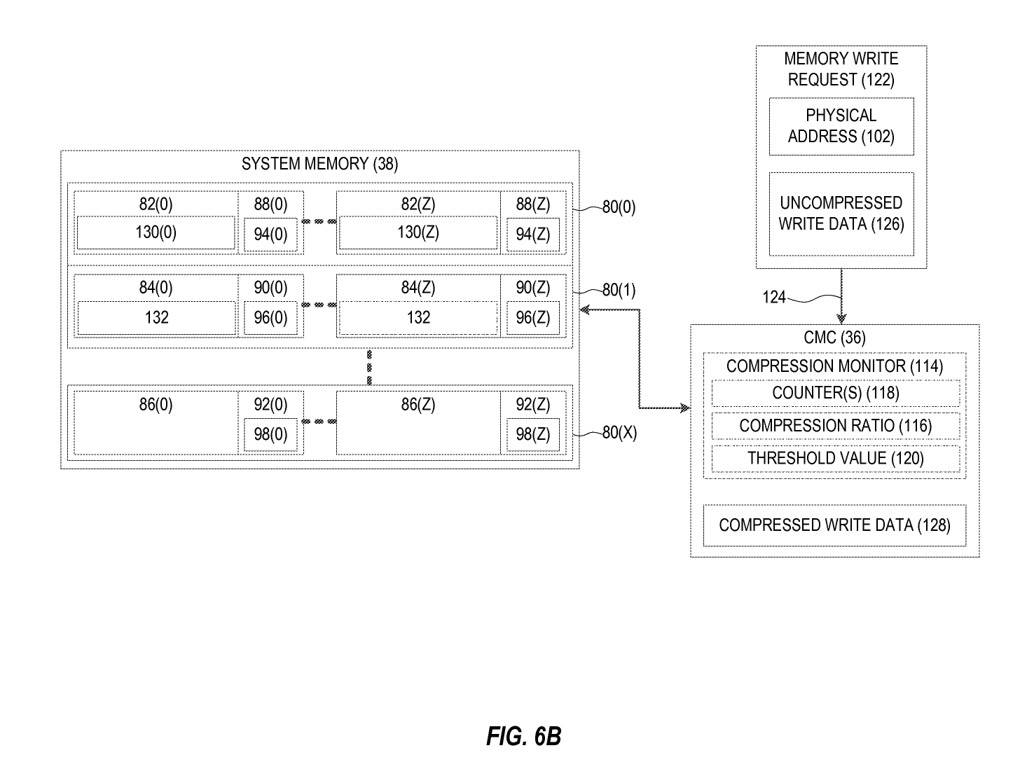

FIGS. 6A and 6B are provided to illustrate exemplary communications flows and exemplary elements of the system memory 38 of FIG. 2 that may be accessed by the CMC 36 of FIG. 3 for providing memory bandwidth compression. In particular, FIG. 6A illustrates exemplary communications flows during a memory read operation including back-to-back reads and early returns, while FIG. 6B illustrates exemplary communications flows during a memory write operation. In describing FIGS. 6A and 6B, elements of FIGS. 3 and 4 are referenced for the sake of clarity.

In FIGS. 6A and 6B, the system memory 38 includes a plurality of memory lines 80(0)-80(X) for storing compressed and uncompressed data. The memory lines 80(0)-80(X) are each subdivided into respective memory blocks 82(0)-82(Z), 84(0)-84(Z), and 86(0)-86(Z), as determined by an underlying memory architecture of the system memory 38. In some aspects, the size of each of the memory blocks 82(0)-82(Z), 84(0)-84(Z), 86(0)-86(Z) represents a smallest amount of data that may be read from the system memory 38 in a memory read operation. For example, in some exemplary memory architectures, each of the memory lines 80(0)-80(X) may comprise 128 bytes of data, subdivided into two 64-byte memory blocks 82(0)-82(Z), 84(0)-84(Z), 86(0)-86(Z). Some aspects may provide that each of the memory lines 80(0)-80(X) may comprise more or fewer bytes of data (e.g., 256 bytes or 64 bytes, as non-limiting examples). Similarly, according to some aspects, the memory blocks 82(0)-82(Z), 84(0)-84(Z), 86(0)-86(Z) within the memory lines 80(0)-80(X) may be larger or smaller (e.g., 128 bytes or 32 bytes, as non-limiting examples). In some aspects, a memory read operation may read fewer bytes than the size of each of the memory blocks 82(0)-82(Z), 84(0)-84(Z), 86(0)-86(Z), but still consume the same amount of memory bandwidth as one of the memory blocks 82(0)-82(Z), 84(0)-84(Z), 86(0)-86(Z).

Each of the memory blocks 82(0)-82(Z), 84(0)-84(Z), 86(0)-86(Z) is associated with one or more corresponding ECC bits 88(0)-88(Z), 90(0)-90(Z), 92(0)-92(Z). ECC bits such as the ECC bits 88(0)-88(Z), 90(0)-90(Z), 92(0)-92(Z) are used conventionally to detect and correct commonly encountered types of internal data corruption within the memory blocks 82(0)-82(Z), 84(0)-84(Z), 86(0)-86(Z). In the example of FIGS. 6A and 6B, one or more of the ECC bits 88(0)-88(Z), 90(0)-90(Z), 92(0)-92(Z) are repurposed to store CIs 94(0)-94(Z), 96(0)-96(Z), 98(0)-98(Z) for the respective memory blocks 82(0)-82(Z), 84(0)-84(Z), 86(0)-86(Z). Although the ECC bits 88(0)-88(Z), 90(0)-90(Z), 92(0)-92(Z) in FIGS. 6A and 6B are depicted as being adjacent to their respective memory blocks 82(0)-82(Z), 84(0)-84(Z), 86(0)-86(Z), it is to be understood that the ECC bits 88(0)-88(Z), 90(0)-90(Z), 92(0)-92(Z) may be located elsewhere within the system memory 38.

The CIs 94(0)-94(Z), 96(0)-96(Z), 98(0)-98(Z) each may comprise one or more bits that indicate a compression status of data stored at a corresponding memory block 82(0)-82(Z), 84(0)-84(Z), 86(0)-86(Z) of the system memory 38. In some aspects, each of the CIs 94(0)-94(Z), 96(0)-96(Z), 98(0)-98(Z) may comprise a single bit indicating whether data in the corresponding memory block 82(0)-82(Z), 84(0)-84(Z), 86(0)-86(Z) is compressed or uncompressed. According to some aspects, each of the CIs 94(0)-94(Z), 96(0)-96(Z), 98(0)-98(Z) may comprise multiple bits that may be used to indicate a compression pattern (e.g., a number of the memory blocks 82(0)-82(Z), 84(0)-84(Z), 86(0)-86(Z) occupied by the compressed data, as a non-limiting example) for each of the corresponding memory blocks 82(0)-82(Z), 84(0)-84(Z), 86(0)-86(Z).

In the example of FIG. 6A, a memory read request 100 specifying a physical address 102 is received by the CMC 36, as indicated by arrow 104. The memory read request 100 further includes a demand word indicator 106 that indicates a memory block 82(0)-82(Z), 84(0)-84(Z), 86(0)-86(Z) containing a demand word. For purposes of illustration, assume first that the physical address 102 corresponds to the memory line 80(0). At the time the memory read request 100 is received, the CMC 36 is unaware of whether the data stored within the memory blocks 82(0)-82(Z) of the memory line 80(0) is compressed or not. The CMC 36 could proceed with reading the entire memory line 80(0), but if the requested data is stored in compressed form in only the memory block 82(0), a read of the memory block 82(Z) would be unnecessary, and would result in increased memory access latency.

Accordingly, the CMC 36 reads the first memory block 82(0) (also referred to herein as the “read memory block 82(0)”). The CMC 36 determines, based on the CI 94(0) stored in the ECC bits 88(0), whether the first memory block 82(0) stores compressed data. As seen in FIG. 6A, the memory blocks 82(0)-82(Z) do not store compressed data, but rather store uncompressed data 108(0)-108(Z). Thus, upon determining that the first memory block 82(0) does not store compressed data, the CMC 36 performs a back-to-back read of an additional memory block 82(Z) of the memory line 80(0). In parallel with the back-to-back read of the memory block 82(Z), the CMC 36 determines, based on the demand word indicator 106, whether the read memory block 82(0) corresponds to a demand word. If so, the CMC 36 returns the read memory block 82(0) while simultaneously performing the back-to-back read of the memory block 82(Z) (i.e., an “early return”). In this manner, memory access latency for accessing the memory block 82(0) may be reduced.

With continuing reference to FIG. 6A, assume now that the physical address 102 corresponds to the memory line 80(1). In this case, the CMC 36 in some aspects reads the first memory block 84(0) of the memory line 80(1), and determines based on the CI 96(0) stored in the ECC bits 90(0) that the first memory block 84(0) contains compressed data 110. Thus, the CMC 36 decompresses the compressed data 110 of the first memory block 84(0) into decompressed memory blocks 112(0)-112(Z). The CMC 36 may then identify one of the decompressed memory blocks 112(0)-112(Z) (e.g., decompressed memory block 112(0)) that contains the demand word based on the demand word indicator 106, and return the decompressed memory block 112(0) prior to returning the remaining decompressed memory blocks 112(0)-112(Z).

Some aspects of the CMC 36 may employ what is referred to herein as “multiple compressed data writes,” in which the compressed data 110, for example, may be stored in each of the memory blocks 84(0)-84(Z) of the memory line 80(1) instead of only the first memory block 84(0). In such aspects, the CMC 36 may improve memory access latency by reading one of the memory blocks, such as the memory blocks 82(Z) or 84(Z), indicated by the demand word indicator 106, rather than reading the first memory block 82(0) or 84(0). If the memory line 80(0)-80(X) read by the CMC 36 is determined to contain uncompressed data 108(0)-108(Z) (e.g., the memory line 80(0)), then the CMC 36 will have read the memory block 82(Z) containing the demand word first, and can return the demand word in parallel with performing the back-to-back read operation to read one or more additional memory blocks 82(0)-82(Z) as described above. This may result in improved memory read access times when reading and returning uncompressed data 108(0)-108(Z). If the memory line 80(0)-80(X) read by the CMC 36 is determined to contain compressed data 110 (e.g., the memory line 80(1)), then the memory block 84(Z) that is indicated by the demand word indicator 106 and that is read by the CMC 36 will contain the compressed data 110. Thus, regardless of which memory block 84(0)-84(Z) is indicated by the demand word indicator 106, the CMC 36 can proceed with decompressing the compressed data 110 into the decompressed memory blocks 112(0)-112(Z). The CMC 36 may then identify and return the decompressed memory block 112(0)-112(Z) containing the demand word as described above.

In some aspects, the CMC 36 may further improve memory access latency by providing an adaptive mode in which the number of reads and/or writes of the compressed data 110 compared to the total number of reads and/or writes may be tracked, and operations for carrying out read operations may be selectively modified based on such tracking. According to some aspects, such tracking may be carried out on a per-CPU basis, a per-workload basis, a per-virtual-machine (VM) basis, a per-container basis, and/or on a per-Quality-of-Service (QoS)-identifier (QoSID) basis, as non-limiting examples. In this regard, the CMC 36, in some aspects, may be configured to provide a compression monitor 114. The compression monitor 114 is configured to track a compression ratio 116 based on at least one of a number of reads of the compressed data 110, a total number of read operations, a number of writes of the compressed data 110, and a total number of write operations, as non-limiting examples. In some aspects, the compression monitor 114 may provide one or more counters 118 for tracking the number of reads of the compressed data 110, the total number of the read operations, the number of writes of the compressed data 110, and/or the total number of the write operations carried out by the CMC 36. The compression ratio 116 may then be determined as a ratio of total read operations to compressed read operations and/or a ratio of total write operations to compressed write operations.

The CMC 36 may further provide a threshold value 120 with which the compression ratio 116 may be compared by the compression monitor 114. If the compression ratio 116 is not below the threshold value 120, the CMC 36 may conclude that data to be read is likely to be compressed, and may perform read operations as described above. However, if the compression ratio 116 is below the threshold value 120, the CMC 36 may determine that data to be read is less likely to be compressed. In such cases, there may be a higher likelihood of the CMC 36 having to perform multiple read operations to retrieve uncompressed data from the memory blocks 82(0)-82(Z), 84(0)-84(Z), 86(0)-86(Z). Accordingly, instead of reading only the first memory block 82(0) of the memory line 80(0) as in the example above, the CMC 36 may read all of the memory blocks 82(0)-82(Z). The CMC 36 may then determine based on the CI 94(0) of the ECC bits 88(0) of the first memory block 82(0) whether the first memory block 82(0) contains the compressed data 110. If the first memory block 82(0) does not contain the compressed data 110, the CMC 36 may return all of the memory blocks 82(0)-82(Z) immediately, without having to perform additional reads to retrieve all uncompressed data stored in the memory line 80(0). If the first memory block 82(0) does contain the compressed data 110, the CMC 36 may decompress and return data as described above.

Referring now to FIG. 6B, the CMC 36 in some aspects may receive a memory write request 122, as indicated by arrow 124. The memory write request 122 includes both uncompressed write data 126 to be written to the system memory 38, as well as the physical address 102 of the system memory 38 to which the uncompressed write data 126 is to be written. For purposes of illustration, assume first that the physical address 102 corresponds to the memory line 80(0). Upon receiving the memory write request 122, the CMC 36 first compresses the uncompressed write data 126 into compressed write data 128. The CMC 36 then determines whether a size of the compressed write data 128 is greater than a size of each memory block 82(0)-82(Z) of the memory line 80(0). In this example, the compressed write data 128 is too large to store within a single one of the memory blocks 82(0)-82(Z). As a result, subsequent reads of the compressed write data 128 will require multiple read operations as well as a decompression operation. The overhead incurred by the multiple read operations and the decompression operation may negate any performance benefit that is realized by storing the compressed write data 128 in a compressed form. Accordingly, the CMC 36 stores the uncompressed write data 126 in the memory blocks 82(0)-82(Z) as uncompressed data 130(0)-130(Z). The CMC 36 also sets the CI 94(0) of the first memory block 82(0) of the memory line 80(0) to indicate the compression status (e.g., uncompressed) of the first memory block 82(0).

With continuing reference to FIG. 6B, assume now that the physical address 102 corresponds to the memory line 80(1), and, upon compressing the uncompressed write data 126, the CMC 36 determines that the size of the compressed write data 128 is smaller than or equal to a size of each memory block 84(0)-84(Z) of the memory line 80(1). In this case, the CMC 36 writes the compressed write data 128 to the first memory block 84(0) of the memory line 80(1) as compressed data 132. The CMC 36 further sets the CI 96(0) of the first memory block 84(0) of the memory line 80(1) to indicate the compression status (e.g., compressed) of the first memory block 84(0).

As noted above, in some aspects, the CMC 36 may support multiple compressed data writes. In the example of FIG. 6B, the CMC 36 employing multiple compressed data writes may write the compressed data 132 to each of the memory blocks 84(0)-84(Z) of the memory line 80(1), rather than writing the compressed data 132 only to the first memory block 84(0). This may enable the CMC 36 to further improve memory read access times by using the demand word indicator 106 of FIG. 6A to read a demand word for the uncompressed data 130(0)-130(Z), while ensuring that the compressed data 132 is properly read regardless of the value of the demand word indicator 106.

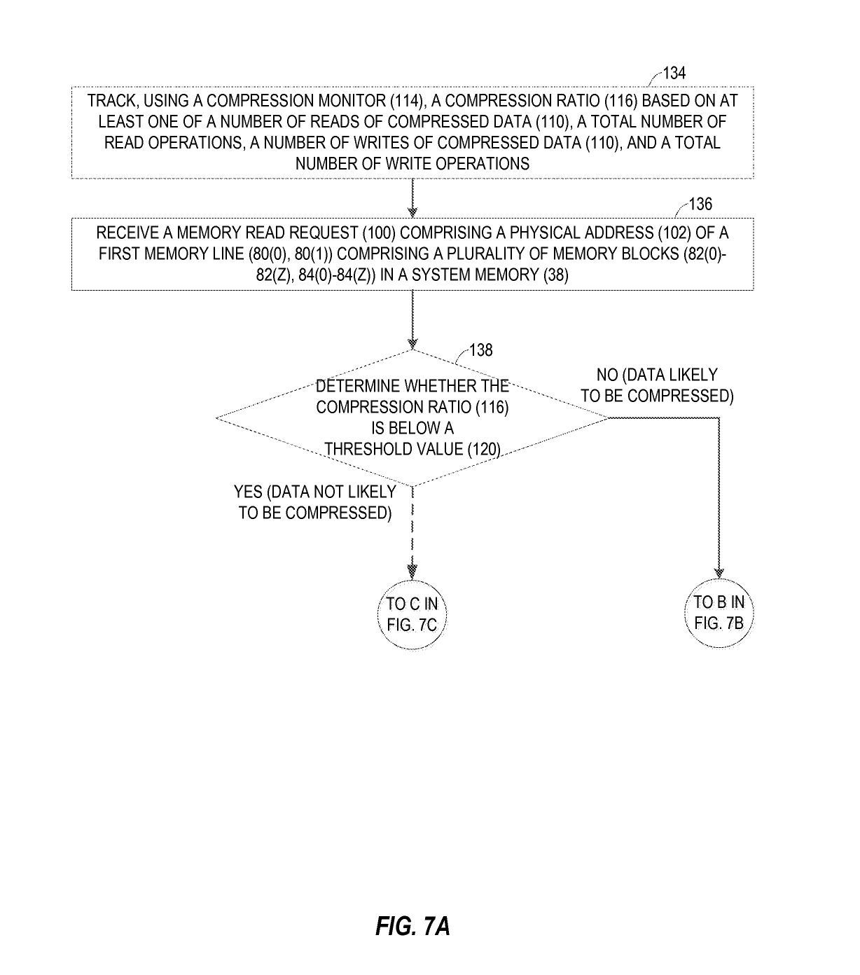

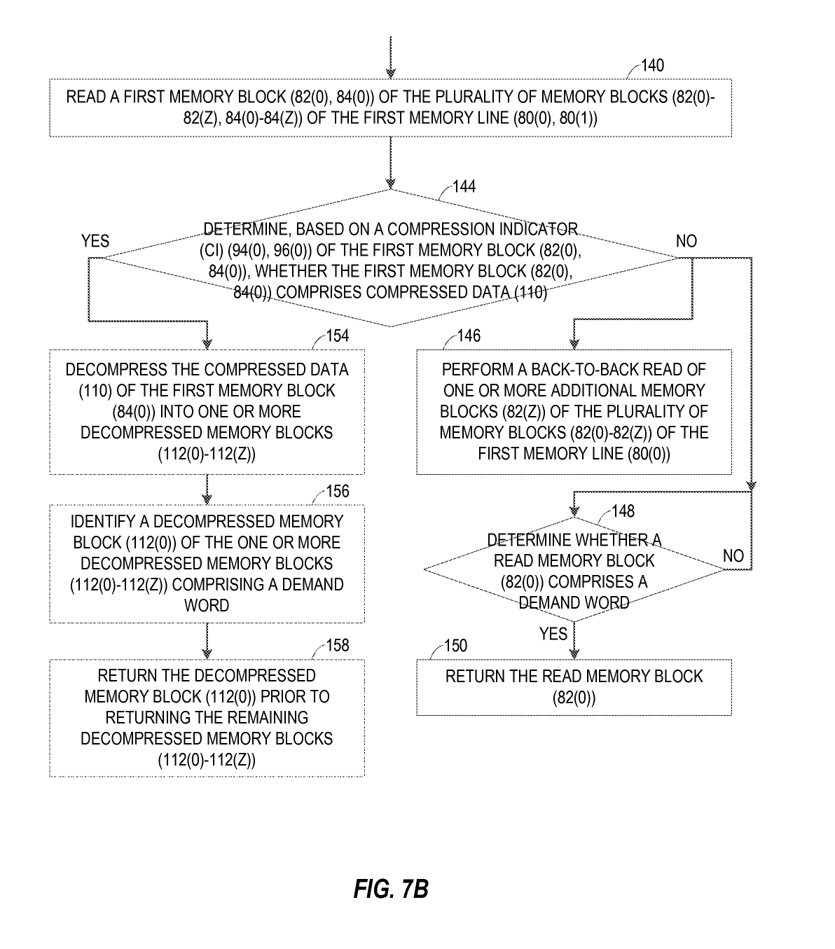

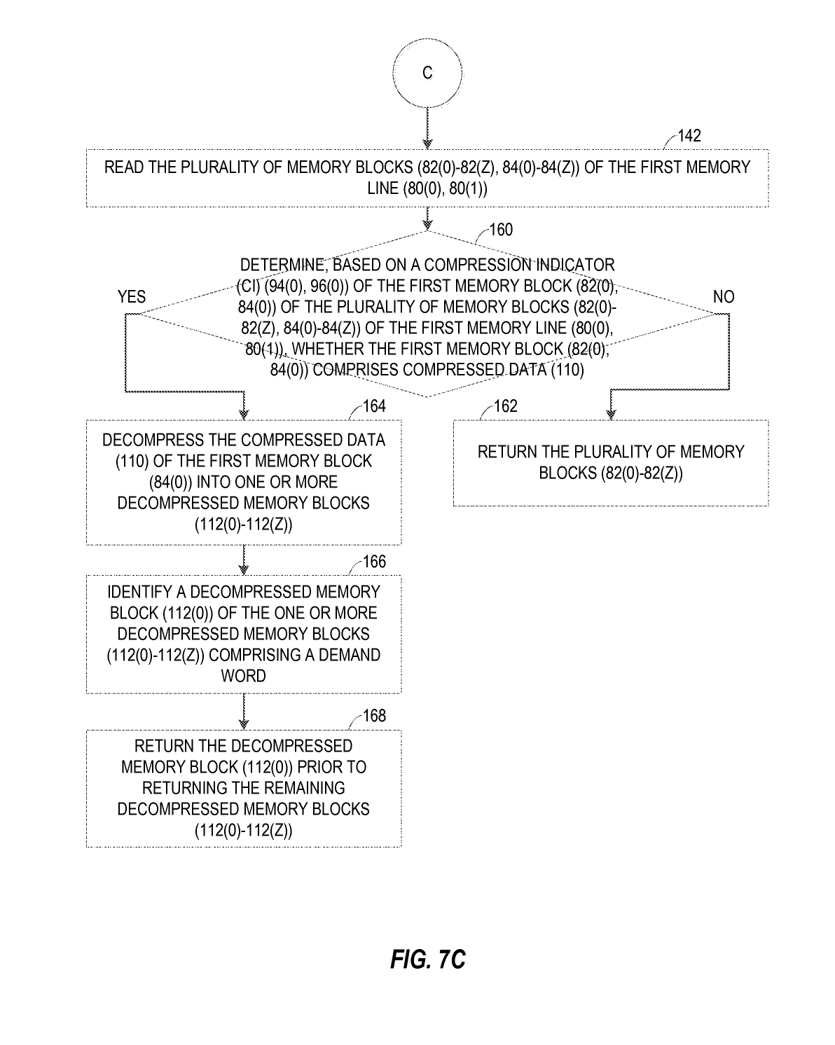

FIGS. 7A-7C are flowcharts illustrating exemplary operations of the CMC 36 of FIG. 3 for performing read operations in providing memory bandwidth compression using back-to-back reads and early returns of read data. In describing FIGS. 7A-7C, elements of FIGS. 2, 3, and 6A-6B are referenced for the sake of clarity. In FIG. 7A, the CMC 36 in some aspects may track, using the compression monitor 114, the compression ratio 116 (block 134). According to some aspects, the compression ratio 116 may be based on at least one of a number of reads of the compressed data 110, a total number of read operations, a number of writes of the compressed data 110, and a total number of write operations. The CMC 36 then receives a memory read request 100 comprising a physical address 102 of a first memory line 80(0), 80(1) comprising a plurality of memory blocks 82(0)-82(Z), 84(0)-84(Z) in the system memory 38 (block 136). In aspects of the CMC 36 employing the compression monitor 114, the CMC 36 may determine whether the compression ratio 116 is below the threshold value 120 (block 138). If the CMC 36 determines at decision block 138 that the compression ratio 116 is not below the threshold value 120, or if the CMC 36 is not employing the compression monitor 114, processing resumes at block 140 of FIG. 7B. However, if the CMC 36 determines at decision block 138 that the compression ratio 116 is below the threshold value 120, processing resumes at block 142 of FIG. 7C.

Referring now to FIG. 7B, the CMC 36 reads a first memory block 82(0), 84(0) of the plurality of memory blocks 82(0)-82(Z), 84(0)-84(Z) of the first memory line 80(0), 80(1) (block 140). The CMC 36 determines, based on a CI 94(0), 96(0) of the first memory block 82(0), 84(0), whether the first memory block 82(0), 84(0) comprises compressed data 110 (block 144). If the CMC 36 determines at decision block 144 that the first memory block 82(0), 84(0) does not comprise the compressed data 110, the CMC 36 performs a back-to-back read of one or more additional memory blocks 82(Z) of the plurality of memory blocks 82(0)-82(Z) of the first memory line 80(0) (block 146). In parallel with the back-to-back read, the CMC 36 also determines whether a read memory block 82(0) comprises a demand word (block 148). If so, the CMC 36 returns the read memory block 82(0) in parallel with the back-to-back read (block 150). If the read memory block 82(0) does not comprise a demand word, processing returns to block 148.

If the CMC 36 determines at decision block 144 of FIG. 7B that the first memory block 82(0), 84(0) does comprise the compressed data 110, the CMC 36 decompresses the compressed data 110 of the first memory block 84(0) into one or more decompressed memory blocks 112(0)-112(Z) (block 154). The CMC 36 next identifies a decompressed memory block 112(0) of the one or more decompressed memory blocks 112(0)-112(Z) comprising a demand word (block 156). The decompressed memory block 112(0) is then returned by the CMC 36 prior to returning the remaining decompressed memory blocks 112(0)-112(Z) (block 158). It is to be understood that the remaining decompressed memory blocks 112(0)-112(Z) that do not comprise the demand word are then subsequently returned by the CMC 36.

As noted above, if the CMC 36 determines at decision block 138 of FIG. 7A that the compression ratio 116 is below the threshold value 120, processing resumes at block 142 of FIG. 7C. Turning now to FIG. 7C, the CMC 36 reads a plurality of memory blocks, such as the memory blocks 82(0)-82(Z), 84(0)-84(Z) of the first memory line 80(0), 80(1), respectively (block 142). The CMC 36 determines, based on a CI 94(0), 96(0) of the first memory block 82(0), 84(0) of the plurality of memory blocks 82(0)-82(Z), 84(0)-84(Z) of the first memory line 80(0), 80(1), whether the first memory block 82(0), 84(0) comprises compressed data 110 (block 160). If the first memory block 82(0), 84(0) does not comprise the compressed data 110, the CMC 36 returns the plurality of memory blocks 82(0)-82(Z) (block 162). However, if the CMC 36 determines at decision block 160 that the first memory block 82(0), 84(0) comprises the compressed data 110, the CMC 36 decompresses the compressed data 110 of the first memory block 84(0) into one or more decompressed memory blocks 112(0)-112(Z) (block 164). The CMC 36 next identifies a decompressed memory block 112(0) of the one or more decompressed memory blocks 112(0)-112(Z) comprising a demand word (block 166). The decompressed memory block 112(0) is then returned by the CMC 36 prior to returning the remaining decompressed memory blocks 112(0)-112(Z) (block 168).

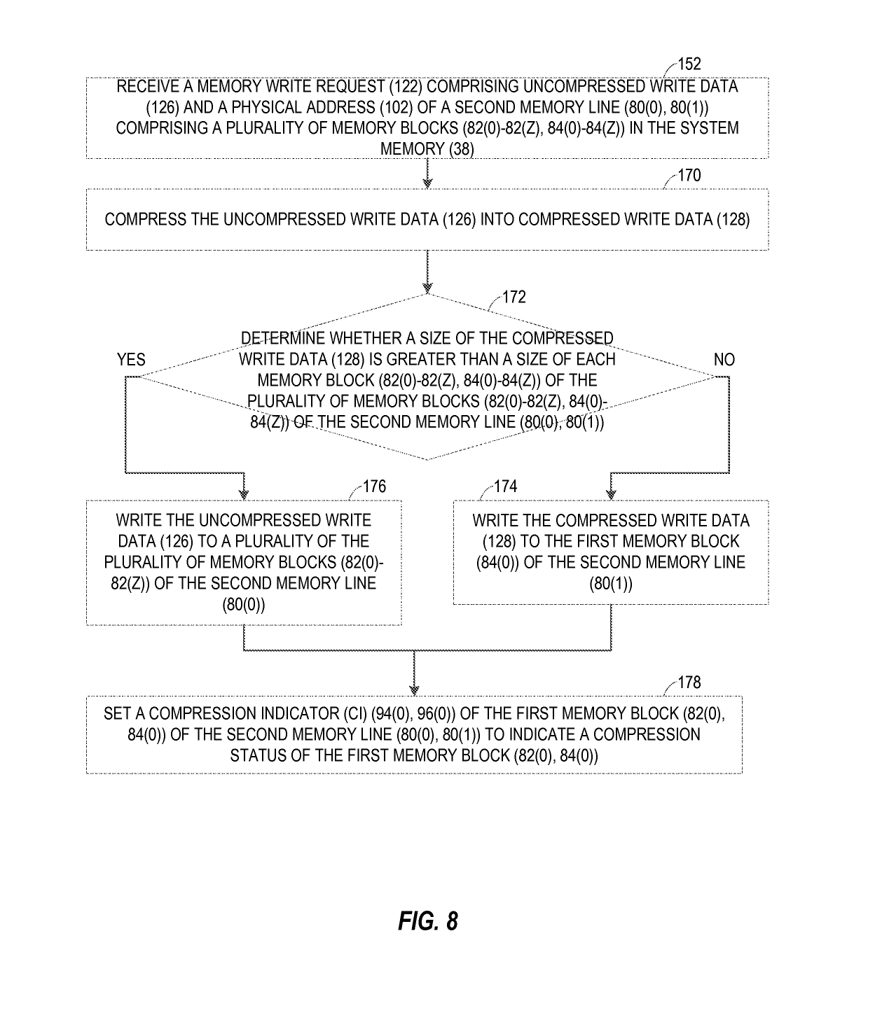

To illustrate exemplary operations of the CMC 36 of FIG. 3 for performing write operations in providing memory bandwidth compression using back-to-back reads and early returns of read data, FIG. 8 is provided. For the sake of clarity, elements of FIGS. 2, 3, and 6A-6B are referenced in describing FIG. 8. In some aspects, operations in FIG. 8 begin with the CMC 36 receiving a memory write request 122 comprising uncompressed write data 126 and a physical address 102 of a second memory line 80(0), 80(1) comprising a plurality of memory blocks 82(0)-82(Z), 84(0)-84(Z) in the system memory 38 (block 152). The CMC 36 may compress the uncompressed write data 126 into compressed write data 128 (block 170). Next, the CMC 36 may determine whether a size of the compressed write data 128 is greater than a size of each memory block 82(0)-82(Z), 84(0)-84(Z) of the plurality of memory blocks 82(0)-82(Z), 84(0)-84(Z) of the second memory line 80(0), 80(1) (block 172). If the size of the compressed write data 128 is not greater than the size of each memory block 82(0)-82(Z), 84(0)-84(Z), the CMC 36 writes the compressed write data 128 to the first memory block 84(0) of the second memory line 80(1) (block 174). However, if the CMC 36 determines at decision block 172 that the size of the compressed write data 128 is greater than the size of each memory block 82(0)-82(Z), 84(0)-84(Z), the CMC 36 writes the uncompressed write data 126 to a plurality of the plurality of memory blocks 82(0)-82(Z) of the second memory line 80(0) (block 176). The CMC 36 then sets a CI 94(0), 96(0) of the first memory block 82(0), 84(0) of the second memory line 80(0), 80(1) to indicate a compression status of the first memory block 82(0), 84(0) (block 178).

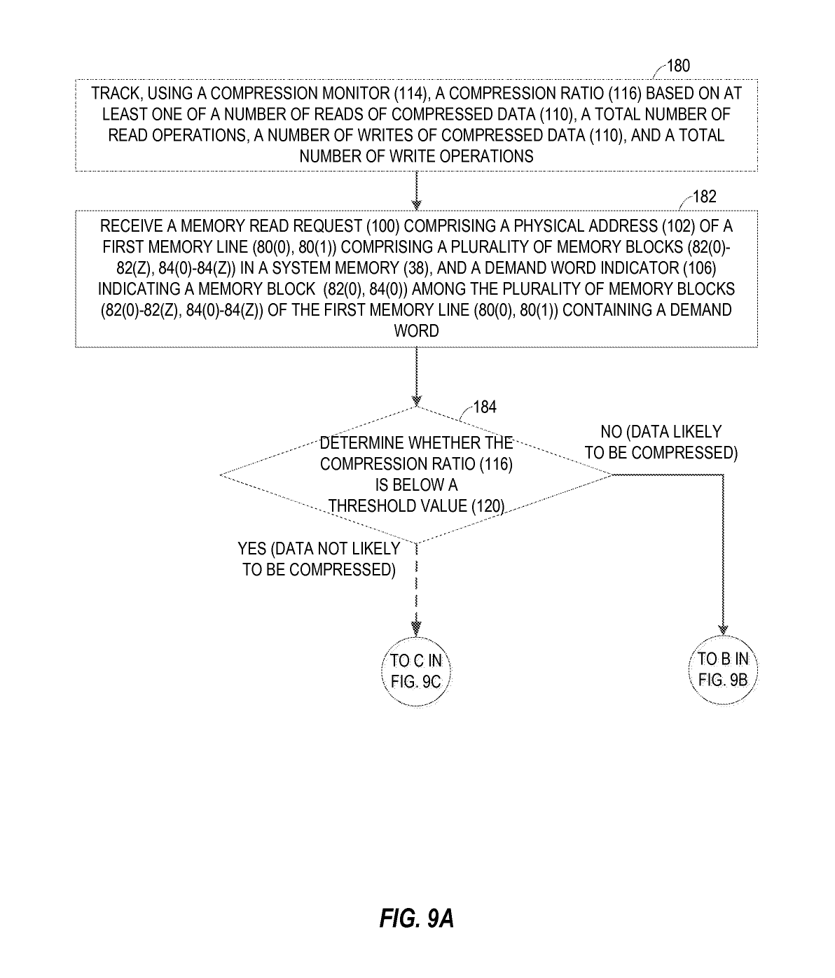

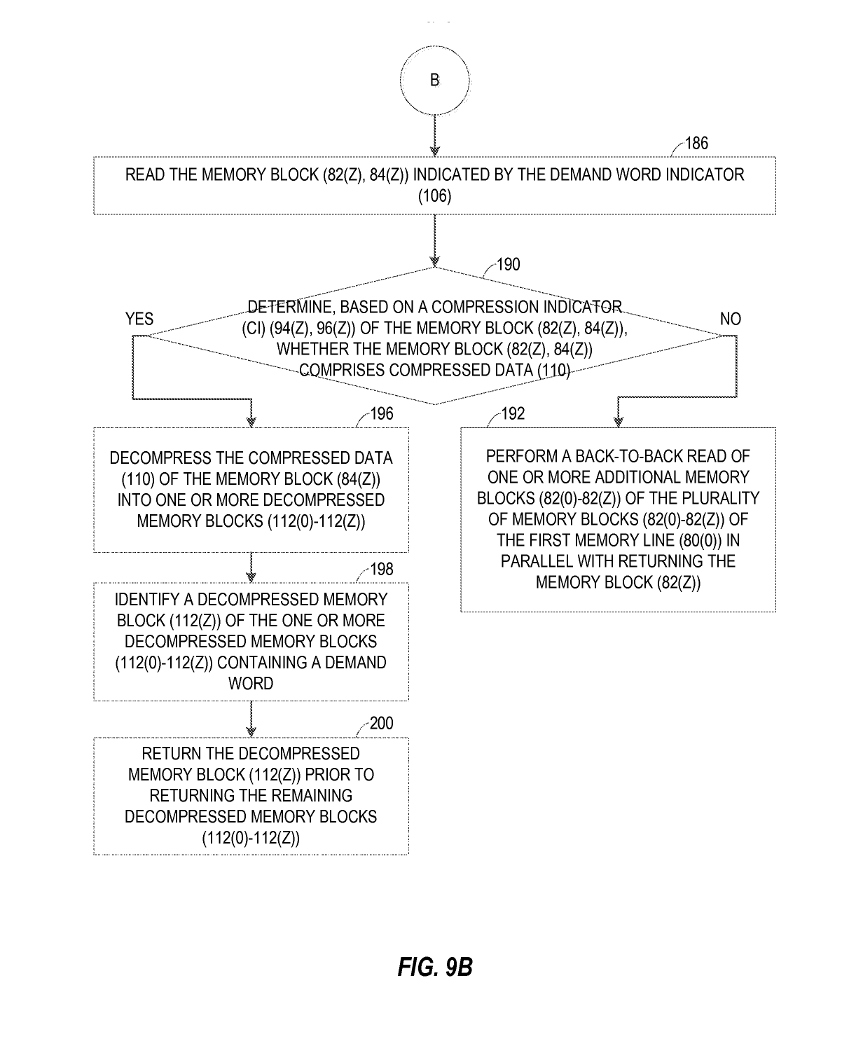

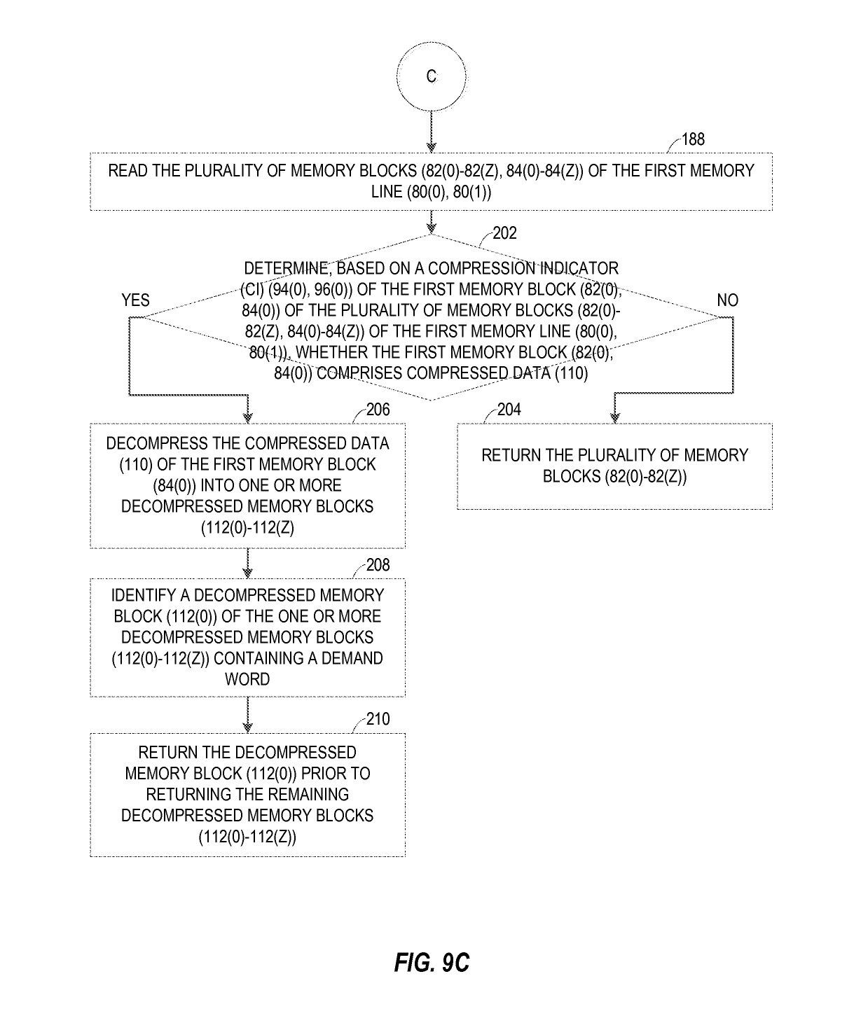

FIGS. 9A-9C are flowcharts illustrating exemplary operations of the CMC 36 of FIG. 3 for performing read operations in providing memory bandwidth compression using back-to-back reads and multiple compressed data writes. For the sake of clarity, elements of FIGS. 2, 3, and 6A-6B are referenced in describing FIGS. 9A-9C. In FIG. 9A, operations according to some aspects begin with the CMC 36 tracking, using a compression monitor 114, a compression ratio 116 (block 180). Some aspects may provide that the compression ratio 116 is based on at least one of a number of reads of the compressed data 110, a total number of read operations, a number of writes of the compressed data 110, and a total number of write operations. The CMC 36 then receives a memory read request 100 comprising a physical address 102 of a first memory line 80(0), 80(1) comprising a plurality of memory blocks 82(0)-82(Z), 84(0)-84(Z) in the system memory 38, and a demand word indicator 106 indicating a memory block 82(0), 84(0) among the plurality of memory blocks 82(0)-82(Z), 84(0)-84(Z) of the first memory line 80(0), 80(1) containing a demand word (block 182).

In aspects of the CMC 36 employing the compression monitor 114, the CMC 36 may determine whether the compression ratio 116 is below the threshold value 120 (block 184). If the compression ratio 116 is not below the threshold value 120, or if the CMC 36 is not employing the compression monitor 114, processing resumes at block 186 of FIG. 9B. However, if the CMC 36 determines at decision block 184 that the compression ratio 116 is below the threshold value 120, processing resumes at block 188 of FIG. 9C.

Referring now to FIG. 9B, the CMC 36 reads the memory block 82(Z), 84(Z) indicated by the demand word indicator 106 (block 186). The CMC 36 next determines, based on a CI 94(Z), 96(Z) of the memory block 82(Z), 84(Z), whether the memory block 82(Z), 84(Z) comprises compressed data 110 (block 190). If the memory block 82(Z), 84(Z) is determined not to comprise the compressed data 110, the CMC 36 performs a back-to-back read of one or more additional memory blocks 82(0)-82(Z) of the plurality of memory blocks 82(0)-82(Z) of the first memory line 80(0) in parallel with returning the memory block 82(Z) (block 192).

However, if the CMC 36 determines at decision block 190 that the memory block 82(Z), 84(Z) comprises the compressed data 110, the CMC 36 decompresses the compressed data 110 of the memory block 84(Z) into one or more decompressed memory blocks 112(0)-112(Z) (block 196). The CMC 36 identifies a decompressed memory block 112(Z) of the one or more decompressed memory blocks 112(0)-112(Z) containing a demand word (block 198). The decompressed memory block 112(Z) is then returned by the CMC 36 prior to returning the remaining decompressed memory blocks 112(0)-112(Z) (block 200).

As noted above, if the CMC 36 determines at decision block 184 of FIG. 9A that the compression ratio 116 is below the threshold value 120, processing resumes at block 188 of FIG. 9C. In FIG. 9C, the CMC 36 reads the plurality of memory blocks 82(0)-82(Z), 84(0)-84(Z) of the first memory line 80(0), 80(1) (block 188). The CMC 36 then determines, based on a CI 94(0), 96(0) of the first memory block 82(0), 84(0) of the plurality of memory blocks 82(0)-82(Z), 84(0)-84(Z) of the first memory line 80(0), 80(1), whether the first memory block 82(0), 84(0) comprises compressed data 110 (block 202). If the first memory block 82(0), 84(0) does not comprise the compressed data 110, the CMC 36 returns the plurality of memory blocks 82(0)-82(Z) (block 204).

If the CMC 36 determines at decision block 202 that the memory block 82(0), 84(0) comprises the compressed data 110, the CMC 36 decompresses the compressed data 110 of the first memory block 84(0) into one or more decompressed memory blocks 112(0)-112(Z) (block 206). The CMC 36 identifies a decompressed memory block 112(0) of the one or more decompressed memory blocks 112(0)-112(Z) containing a demand word (block 208). The decompressed memory block 112(0) is then returned by the CMC 36 prior to returning the remaining decompressed memory blocks 112(0)-112(Z) (block 210).

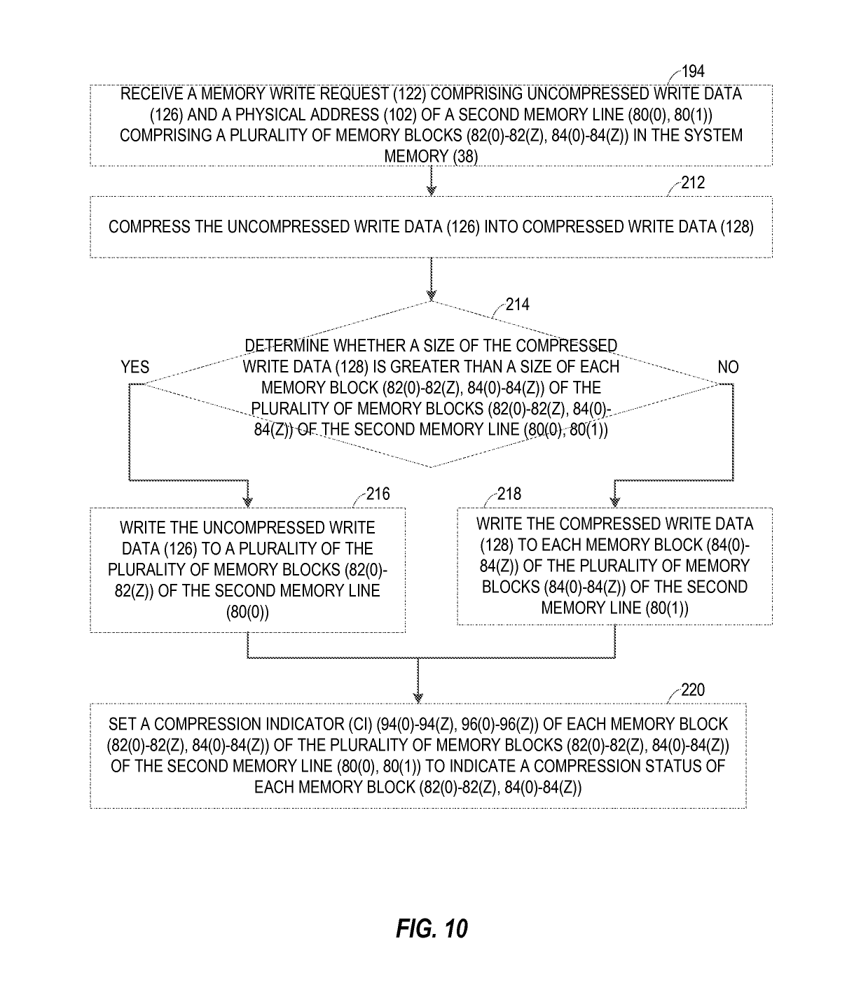

To illustrate exemplary operations of the CMC 36 of FIG. 3 for performing write operations in providing memory bandwidth compression using back-to-back reads and multiple compressed data writes, FIG. 10 is provided. For the sake of clarity, elements of FIGS. 2, 3, and 6A-6B are referenced in describing FIG. 10. In some aspects, operations in FIG. 10 begin with the CMC 36 receiving a memory write request 122 comprising uncompressed write data 126 and a physical address 102 of a second memory line 80(0), 80(1) comprising a plurality of memory blocks 82(0)-82(Z), 84(0)-84(Z) in the system memory 38 (block 194). The CMC 36 may compress the uncompressed write data 126 into compressed write data 128 (block 212). The CMC 36 may then determine whether a size of the compressed write data 128 is greater than a size of each memory block 82(0)-82(Z), 84(0)-84(Z) of the plurality of memory blocks 82(0)-82(Z), 84(0)-84(Z) of the second memory line 80(0), 80(1) (block 214). If the size of the compressed write data 128 is greater than a size of each memory block 82(0)-82(Z), 84(0)-84(Z), the CMC 36 may write the uncompressed write data 126 to a plurality of the plurality of memory blocks 84(0)-84(Z) of the second memory line 80(1) (block 216). However, if the CMC 36 determines at decision block 214 that the size of the compressed write data 128 is not greater than the size of each memory block 82(0)-82(Z), 84(0)-84(Z), the CMC 36 may write the compressed write data 128 to each memory block 84(0)-84(Z) of the plurality of memory blocks 84(0)-84(Z) of the second memory line 80(1) (block 218). The CMC 36 then sets a CI 94(0)-94(Z), 96(0)-96(Z) of each memory block 82(0)-82(Z), 84(0)-84(Z) of the plurality of memory blocks 82(0)-82(Z), 84(0)-84(Z) of the second memory line 80(0), 80(1) to indicate a compression status of each memory block 82(0)-82(Z), 84(0)-84(Z) (block 220).

In some aspects, a value of a CI comprising multiple bits may indicate a compression status and/or a fixed data pattern stored in a memory block such as one of the memory blocks 82(0)-82(Z). As a non-limiting example, for a CI of two (2) bits, a value of “00” may indicate that the corresponding memory block is uncompressed, while a value of “01” may indicate that the corresponding memory block is compressed. A value of “11” may indicate that a fixed pattern (e.g., all zeroes (0s) or all ones (1s)) is stored in the corresponding memory block.

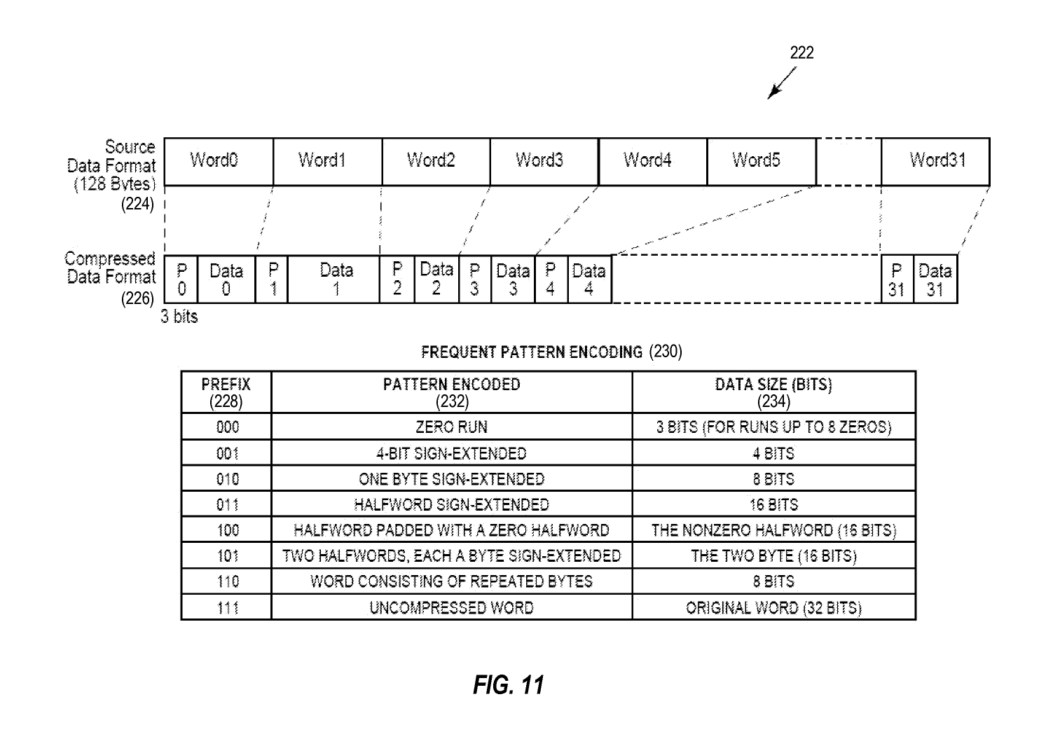

In this regard, FIG. 11 illustrates a frequent pattern compression data compression mechanism 222. In this regard, source data in a source data format 224 to be compressed is shown by example as 128 bytes. A compressed data format 226 is shown below. The compressed data format 226 is provided in a format of prefix codes Px and data behind the prefix as Datax. The prefix is 3-bits. The prefix codes are shown in a prefix code column 228 in a frequent pattern encoding table 230 that shows the pattern encoded in a pattern encoded column 232 for a given prefix code in the prefix code column 228. The data size for the pattern encoded is provided in a data size column 234 of the frequent pattern encoding table 230.

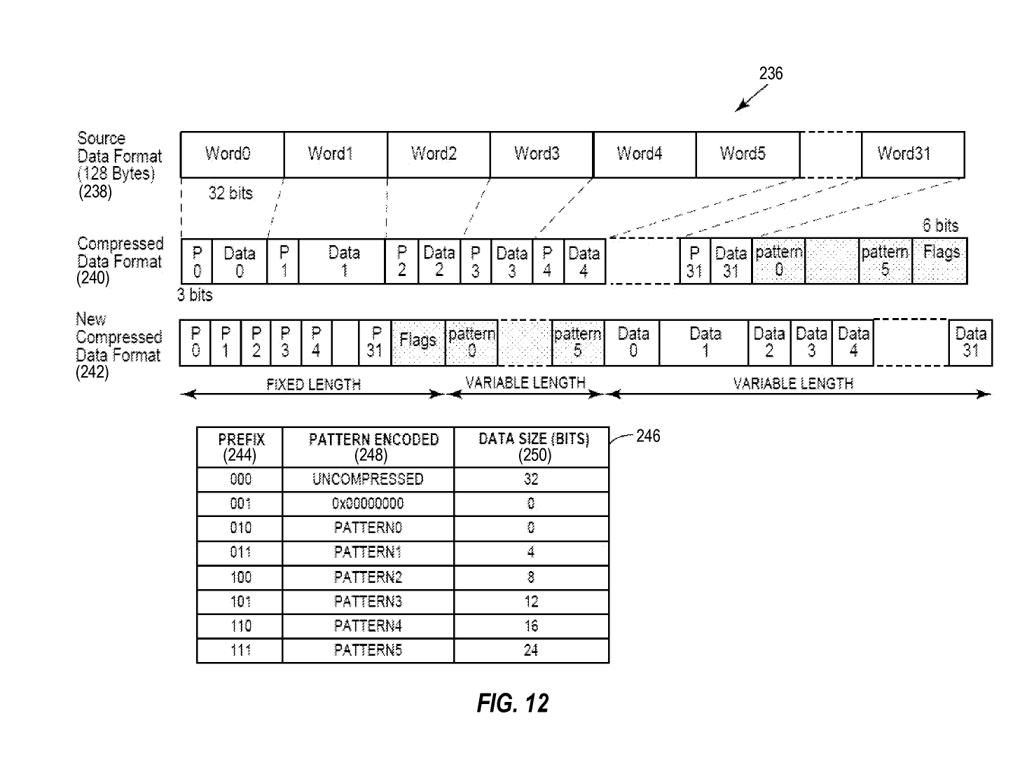

FIG. 12 illustrates a 32-bit frequent pattern compression data compression mechanism 236. In this regard, source data in a source data format 238 to be compressed is shown by example as 128 bytes. A compressed data format 240 is shown below. The compressed data format 240 is provided in a format of prefix Px and data immediately behind the prefix as Datax. A new compressed data format 242 is provided in a different format of prefix codes Px, data Datax, flags, and patterns, which are organized to be grouped together for efficiency purposes. The prefix code is 3-bits. The prefix codes are shown in a prefix code column 244 in a frequent pattern encoding table 246 that shows the pattern encoded in a pattern encoded column 248 for a given prefix code in the prefix code column 244. The data size for the pattern encoded is provided in a data size column 250 of the frequent pattern encoding table 246. The prefix code 000 signifies an uncompressed pattern, which would be data of the full size of 32-bits in the new compressed data format 242. The prefix code 001 signifies an all zero data block, which can be provided as 0 bits in the data of the new compressed data format 242. With a 3-bit prefix, prefix codes 010-111 can be used to encode other specific patterns that are recognized in the source data, which in this example are patterns in 0, 4, 8, 12, 16, and 24 bits respectively.

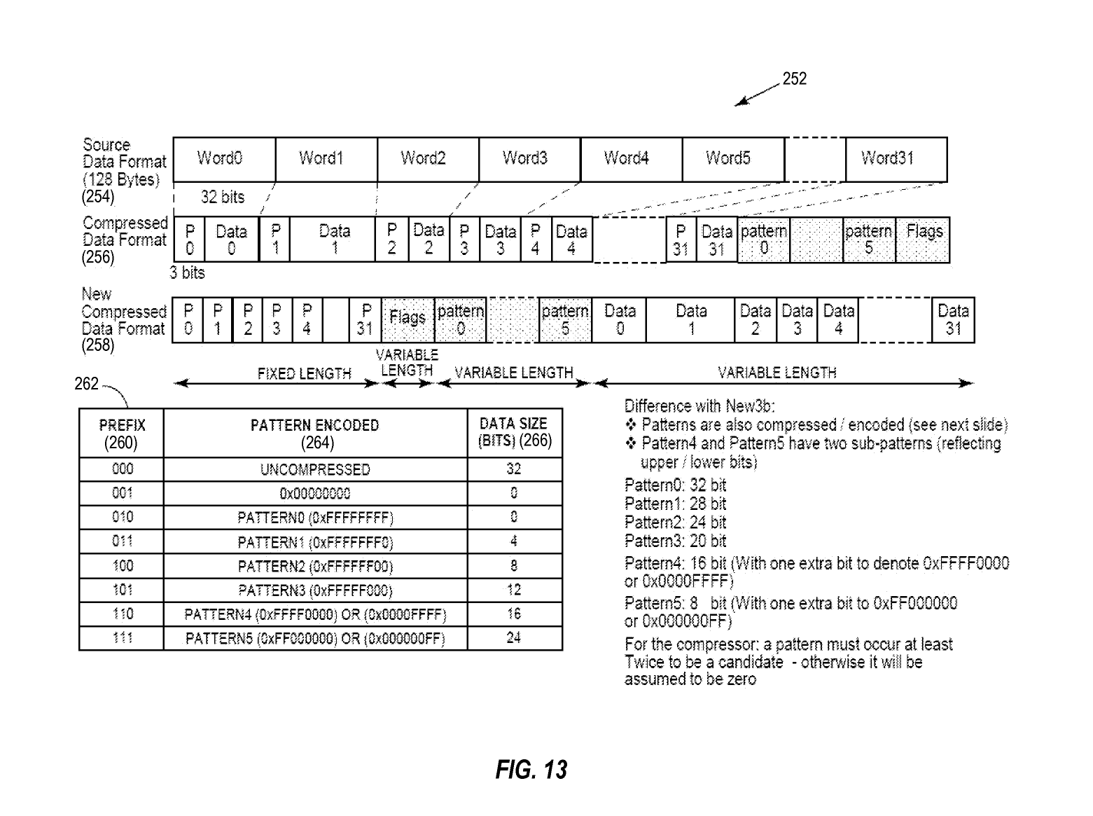

FIG. 13 illustrates an example of 32-bit frequent pattern compression data compression mechanism 252. In this regard, source data in a source data format 254 to be compressed is shown by example as 128 bytes. A compressed data format 256 is shown below. The compressed data format 256 is provided in a format of prefix Px and data behind the prefix as Datax. A new compressed data format 258 is provided in a different format of prefix codes Px, data Datax, flags, and patterns, which are organized to be grouped together for efficiency purposes. The prefix code is 3-bits. The prefix codes are shown in a prefix code column 260 in a frequent pattern encoding table 262 that shows the pattern encoded in a pattern encoded column 264 for a given prefix code in the prefix code column 260. The data size for the pattern encoded is provided in a data size column 266 of the frequent pattern encoding table 262. The prefix code 000 signifies an uncompressed pattern, which would be data of the full size of 32-bits in the new compressed data format 258. The prefix code 001 signifies an all zero data block, which can be provided as 0 bits in the data of the new compressed data format 258. Prefix code 010 signifies pattern 0xFFFFFFFF, which is a specific pattern and thus requires 0-bit data size in the compressed data according to the new compressed data format 258. Other patterns are shown in the frequent pattern encoding table 262 for prefix codes 011-111. The flags field in the new compressed data format 258 indicates which patterns for prefix codes 001-111 are present in the data portions (i.e., Datax) of the compressed data. If the pattern is present in the compressed data, the patterns are stored in the new compressed data format 258 that can then be consulted to recreate the uncompressed data. The data fields include the compressed data according to the prefix code associated with the data field in the new compressed data format 258.

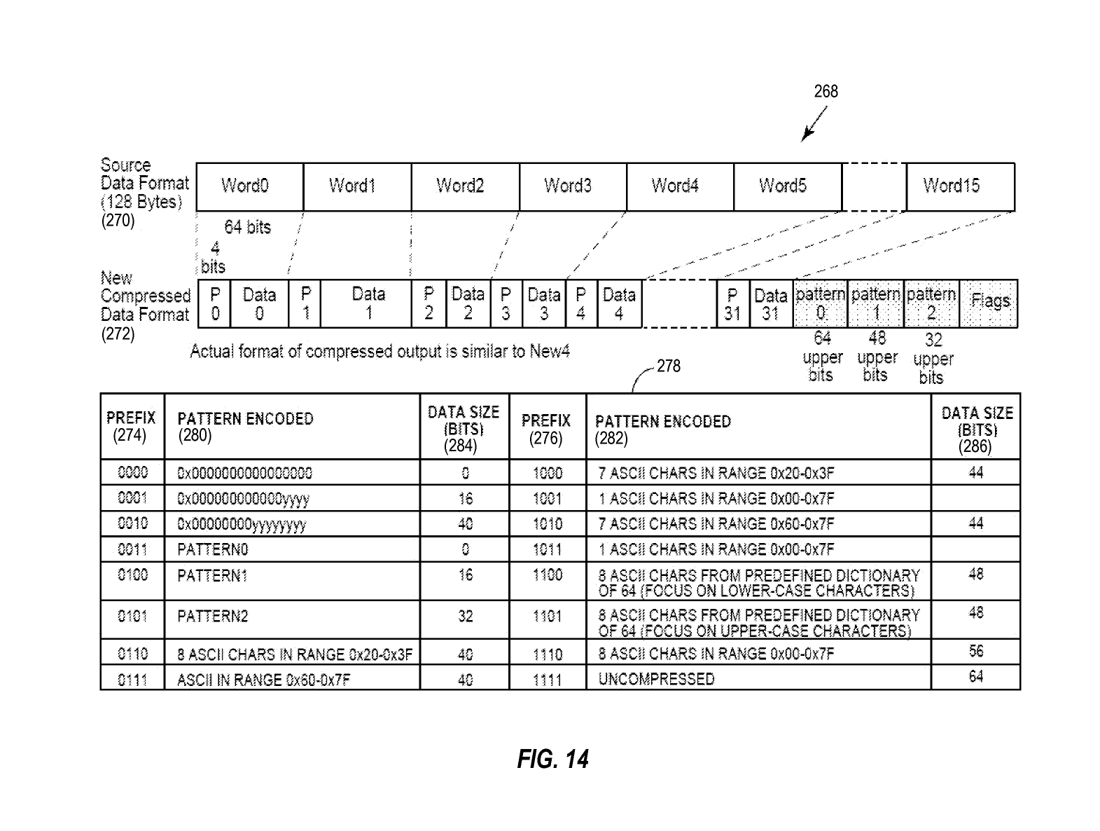

FIG. 14 illustrates another example of 64-bit frequent pattern compression data compression mechanism 268. In this regard, source data in a source data format 270 to be compressed is shown by example as 128 bytes. A new compressed data format 272 is provided in a different format of prefix codes Px, data Datax, flags, and patterns, which are organized to be grouped together for efficiency purposes. The prefix code is 4-bits. The prefix codes are shown in prefix code columns 274, 276 in a frequent pattern encoding table 278 that shows the pattern encoded in pattern encoded columns 280, 282 for a given prefix code in the prefix code columns 274, 276. The data size for the pattern encoded is provided in data size columns 284, 286 of the frequent pattern encoding table 278. The prefix code 0000 signifies an all zero data block, which can be provided as 0 bits in the data of the new compressed data format 272. Other patterns are shown in the frequent pattern encoding table 278 for prefix codes 0001-1111, which include ASCII patterns for frequently occurring ASCII patterns. The flags field in the new compressed data format 272 indicates which patterns for prefix codes 0001-1111 are present in the data portions (i.e., Datax) compressed data. If the pattern is present in the compressed data, the patterns are stored in the new compressed data format 272 that can then be consulted to recreate the uncompressed data. The data fields include the compressed data according to the prefix code associated with the data field in the new compressed data format 272.

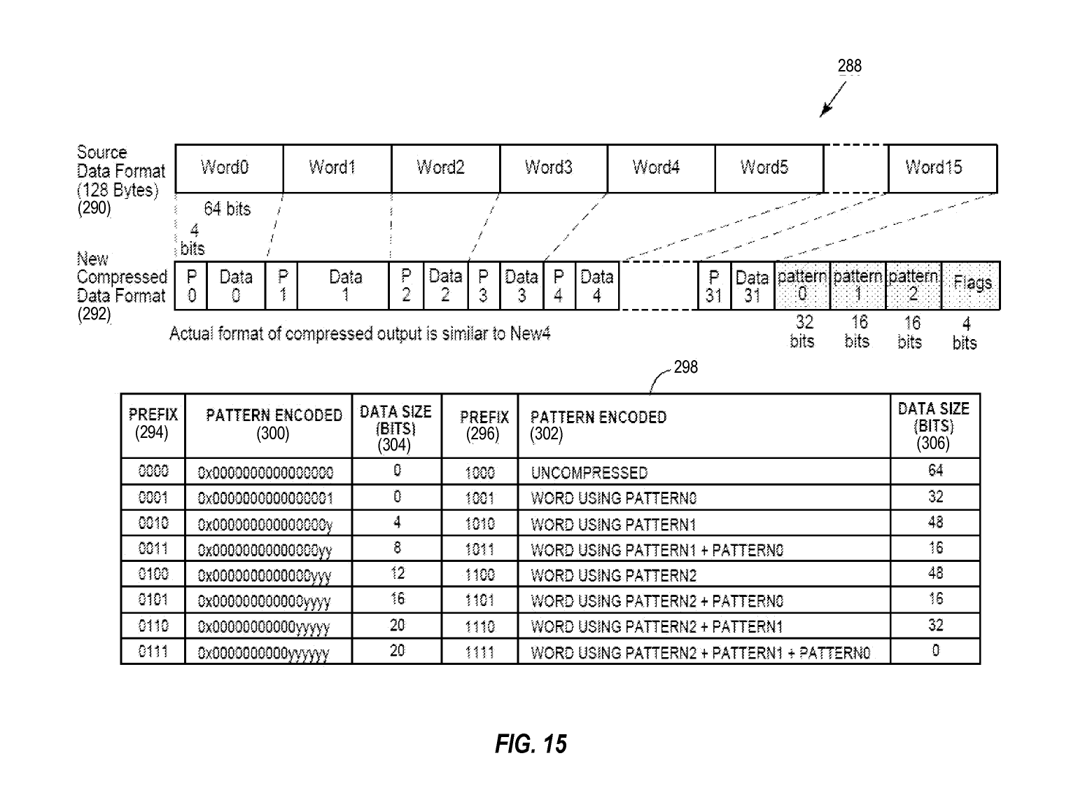

FIG. 15 illustrates another example of 64-bit frequent pattern compression data compression mechanism 288. In this regard, source data in a source data format 290 to be compressed is shown by example as 128 bytes. A new compressed data format 292 is provided in a different format of prefix codes Px, data Datax, flags, and patterns, which are organized to be grouped together for efficiency purposes. The prefix code is 4-bits. The prefix codes are shown in prefix code columns 294, 296 in a frequent pattern encoding table 298 that shows the pattern encoded in pattern encoded columns 300, 302 for a given prefix code in the prefix code columns 294, 296. The data size for the pattern encoded is provided in data size columns 304, 306 of the frequent pattern encoding table 298. The prefix code 0000 signifies an all zero data block, which can be provided as 0 bits in the data of the new compressed data format 292. Other patterns are shown in the frequent pattern encoding table 298 for prefix codes 0001-1111, which can include combinations of fixed patterns. The flags field in the new compressed data format 292 indicates which patterns for prefix codes 0001-1111 are present in the data portions (i.e., Datax) in the compressed data. If the pattern is present in the compressed data, the patterns are stored in the new compressed data format 292, which can then be consulted during data compression to recreate the uncompressed data. The prefix code P0-P31 can link to the patterns, which are used along with the corresponding data (Datax) to recreate the full length data in uncompressed format. The data fields include the compressed data according to the prefix code associated with the data field in the new compressed data format 292.

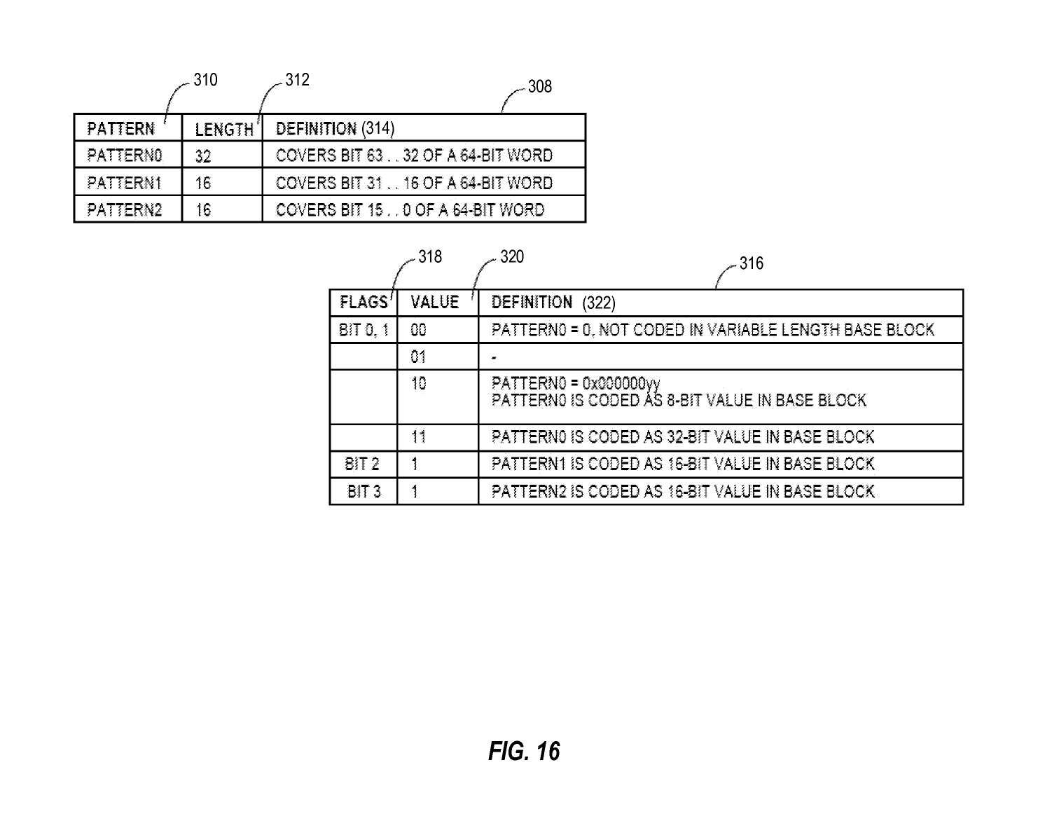

Examples of fixed patterns that can be used with the frequent pattern compression data compression mechanism 288 in FIG. 15 is shown in table 308 in FIG. 16, where the fixed patterns are provided in a pattern column 310, with its length in a length column 312 and the definition of the pattern in a pattern definition column 314. The flags definitions are shown in a flag definition table 316 to allow the CMC 36 to correlate a given pattern linked to a prefix code to a definition used to create uncompressed data. The flag definition table 316 includes the bits for a given flag in a flags column 318, the value of the bits for a given flag in a flag value column 320, and a flag definition for a given flag in a flag definition column 322.

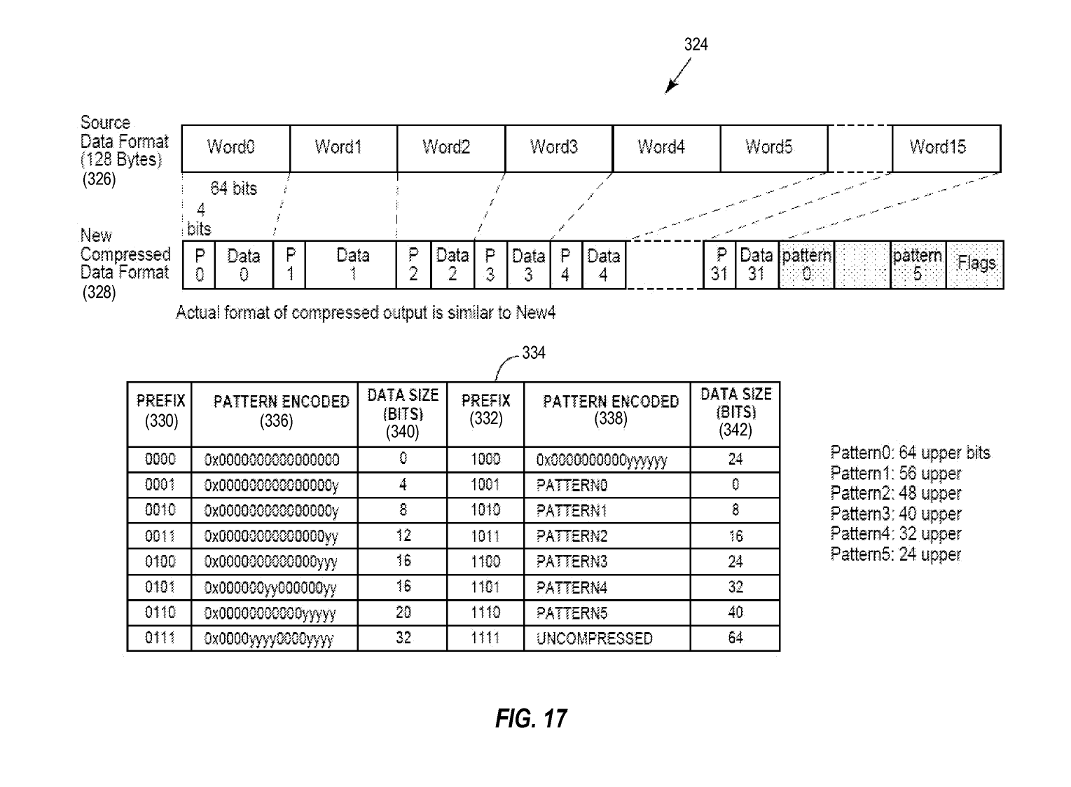

FIG. 17 illustrates another example of a 64-bit frequent pattern compression data compression mechanism 324. In this regard, source data in a source data format 326 to be compressed is shown by example as 128 bytes. A new compressed data format 328 is provided in a different format of prefix codes Px, data Datax, flags, and patterns, which are organized to be grouped together for efficiency purposes. The prefix code is 4-bits. The prefix codes are shown in prefix code columns 330, 332 in a frequent pattern encoding table 334 that shows the pattern encoded in pattern encoded columns 336, 338 for a given prefix code in the prefix code columns 330, 332. The data size for the pattern encoded is provided in data size columns 340, 342 of the frequent pattern encoding table 334. The prefix code 0000 signifies an all zero data block, which can be provided as 0 bits in the data of the new compressed data format 328. The prefix code 1111 signifies a data block that is not compressed in the new compressed data format 328. Other patterns are shown in the frequent pattern encoding table 334 for prefix codes 0001-1110, which can include combinations of defined patterns as shown therein. The flags field in the new compressed data format 328 indicates which patterns for prefix codes 0000-1110 are present in the data portions (i.e., Datax) of the compressed data. If the pattern is present in the compressed data, the patterns are stored in the new compressed data format 328 that can then be consulted to recreate the uncompressed data. The new compressed data format 328 is shown as only containing patterns 0-5, because these were the only patterns accounted for in the prefix codes 0000-1110 present in the source data in this example. The data fields include the compressed data according to the prefix code associated with the data field in the new compressed data format 328.

Providing memory bandwidth compression using back-to-back read operations by CMCs in a CPU-based system according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

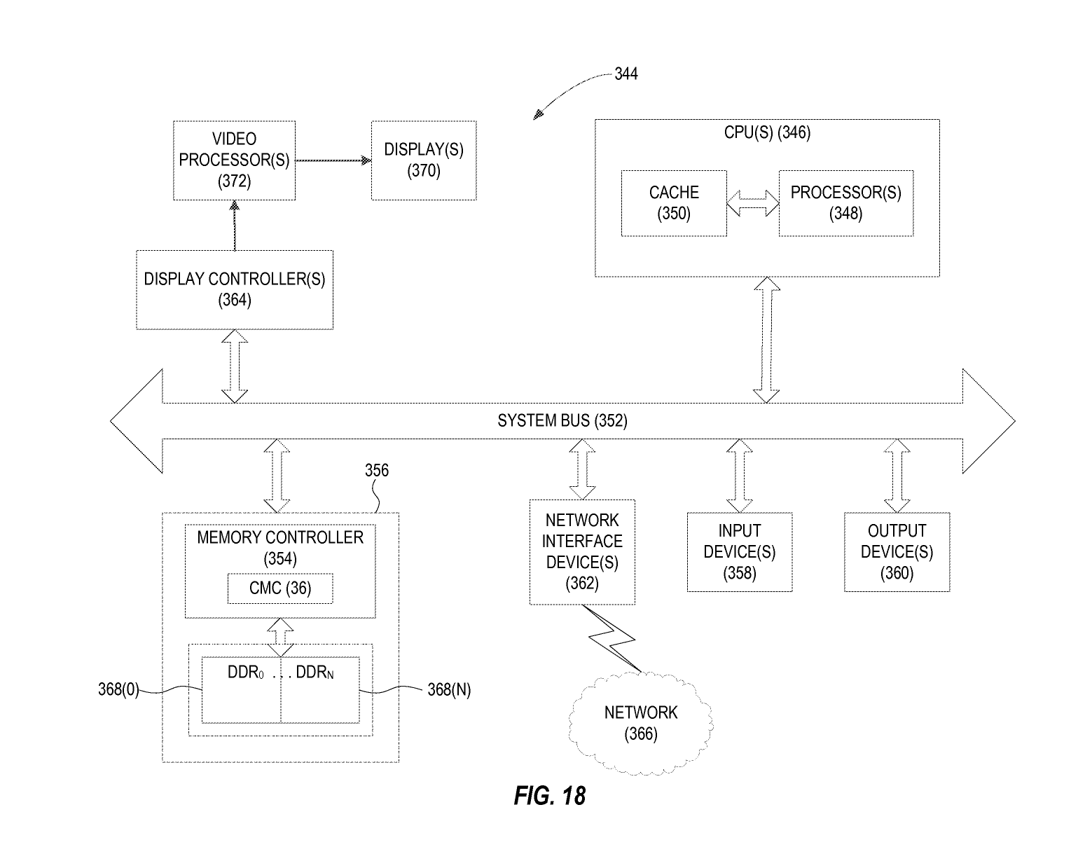

In this regard, FIG. 18 illustrates an example of a processor-based system 344 that can employ the SoC 10 of FIG. 1 with the CMC 36 of FIG. 2. In this example, the processor-based system 344 includes one or more CPUs 346, each including one or more processors 348. The CPU(s) 346 may have cache memory 350 coupled to the processor(s) 348 for rapid access to temporarily stored data. The CPU(s) 346 is coupled to a system bus 352 and can intercouple devices included in the processor-based system 344. As is well known, the CPU(s) 346 communicates with these other devices by exchanging address, control, and data information over the system bus 352. For example, the CPU(s) 346 can communicate bus transaction requests to a memory controller 354 as an example of a slave device. Although not illustrated in FIG. 18, multiple system buses 352 could be provided.

Other devices can be connected to the system bus 352. As illustrated in FIG. 18, these devices can include a memory system 356, one or more input devices 358, one or more output devices 360, one or more network interface devices 362, and one or more display controllers 364, as examples. The input device(s) 358 can include any type of input device, including but not limited to input keys, switches, voice processors, etc. The output device(s) 360 can include any type of output device, including but not limited to audio, video, other visual indicators, etc. The network interface device(s) 362 can be any devices configured to allow exchange of data to and from a network 366. The network 366 can be any type of network, including but not limited to a wired or wireless network, a private or public network, a local area network (LAN), a wide local area network, wireless local area network, BLUETOOTH (BT), and the Internet. The network interface device(s) 362 can be configured to support any type of communications protocol desired. The memory system 356 can include one or more memory units 368(0)-368(N).

The CPU(s) 346 may also be configured to access the display controller(s) 364 over the system bus 352 to control information sent to one or more displays 370. The display controller(s) 364 sends information to the display(s) 370 to be displayed via one or more video processors 372, which process the information to be displayed into a format suitable for the display(s) 370. The display(s) 370 can include any type of display, including but not limited to a cathode ray tube (CRT), a liquid crystal display (LCD), a light emitting diode (LED) display, a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A compressed memory controller (CMC), comprising a memory interface configured to access a system memory via a system bus;
the CMC configured to:
receive a memory read request comprising a physical address of a first memory line comprising a plurality of memory blocks in the system memory;
read a first memory block of the plurality of memory blocks of the first memory line;
determine, based on a compression indicator (CI) of the first memory block, whether the first memory block comprises compressed data; and
responsive to determining that the first memory block does not comprise the compressed data:
perform a back-to-back read of one or more additional memory blocks of the plurality of memory blocks of the first memory line; and
in parallel with the back-to-back read:
determine whether a read memory block comprises a demand word; and
responsive to determining that the read memory block comprises the demand word, return the read memory block.

2. The CMC of claim 1, further configured to, responsive to determining that the first memory block comprises the compressed data:
decompress the compressed data of the first memory block into one or more decompressed memory blocks; and
determine a decompressed memory block of the one or more decompressed memory blocks comprising the demand word; and
return the decompressed memory block comprising the demand word prior to returning the remaining one or more decompressed memory blocks.

3. The CMC of claim 1, further configured to:
receive a memory write request comprising uncompressed write data and a physical address of a second memory line comprising a plurality of memory blocks in the system memory;
compress the uncompressed write data into compressed write data;
determine whether a size of the compressed write data is greater than a size of each memory block of the plurality of memory blocks of the second memory line;
responsive to determining that the size of the compressed write data is not greater than the size of each memory block of the plurality of memory blocks of the second memory line, write the compressed write data to a first memory block of the second memory line;
responsive to determining that the size of the compressed write data is greater than the size of each memory block of the plurality of memory blocks of the second memory line, write the uncompressed write data to a plurality of the plurality of memory blocks of the second memory line; and
set the CI of the first memory block of the plurality of memory blocks of the second memory line to indicate a compression status of the first memory block.

4. The CMC of claim 1, further comprising a compression monitor configured to track a compression ratio based on at least one of a number of reads of the compressed data, a total number of read operations, a number of writes of the compressed data, and a total number of write operations.

5. The CMC of claim 4, wherein the compression monitor is configured to track the compression ratio on one or more of a per-central processing unit (CPU) basis, a per-workload basis, a per-virtual-machine (VM) basis, a per-container basis, and on a per-Quality-of-Service (QoS)-identifier (QoSID) basis, as non-limiting examples.

6. The CMC of claim 4, wherein the compression monitor comprises one or more counters for tracking the at least one of the number of reads of the compressed data, the total number of the read operations, the number of writes of the compressed data, and the total number of the write operations.

7. The CMC of claim 4, further configured to:
responsive to receiving the memory read request, determine whether the compression ratio is below a threshold value; and
responsive to determining that the compression ratio is below the threshold value:
read the plurality of memory blocks of the first memory line;
determine, based on the CI of the first memory block of the plurality of memory blocks of the first memory line, whether the first memory block comprises the compressed data;
responsive to determining that the first memory block comprises the compressed data:
decompress the compressed data of the first memory block into one or more decompressed memory blocks;
identify a decompressed memory block of the one or more decompressed memory blocks containing the demand word; and
return the decompressed memory block; and
responsive to determining that the first memory block does not comprise the compressed data, return the plurality of memory blocks; and
the CMC configured to read the first memory block of the plurality of memory blocks of the first memory line responsive to determining that the compression ratio equals or exceeds the threshold value.

8. The CMC of claim 1 integrated into an integrated circuit (IC).

9. The CMC of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

10. A compressed memory controller (CMC), comprising a memory interface configured to access a system memory via a system bus;
the CMC configured to:
receive a memory read request comprising:
a physical address of a first memory line comprising a plurality of memory blocks in the system memory; and
a demand word indicator indicating a memory block among the plurality of memory blocks of the first memory line containing a demand word;
read the memory block indicated by the demand word indicator;
determine, based on a compression indicator (CI) of the memory block, whether the memory block comprises compressed data; and
responsive to determining that the memory block does not comprise the compressed data, perform a back-to-back read of one or more additional memory blocks of the plurality of memory blocks of the first memory line in parallel with returning the memory block.

11. The CMC of claim 10, further configured to, responsive to determining that the memory block comprises the compressed data:
decompress the compressed data of the memory block into one or more decompressed memory blocks;
identify a decompressed memory block of the one or more decompressed memory blocks comprising the demand word; and
return the decompressed memory block comprising the demand word prior to returning the remaining one or more decompressed memory blocks.

12. The CMC of claim 10, further configured to:
receive a memory write request comprising uncompressed write data and a physical address of a second memory line comprising a plurality of memory blocks in the system memory;
compress the uncompressed write data into compressed write data;
determine whether a size of the compressed write data is greater than a size of each memory block of the plurality of memory blocks of the second memory line;
responsive to determining that the size of the compressed write data is not greater than the size of each memory block of the plurality of memory blocks of the second memory line, write the compressed write data to each memory block of the plurality of memory blocks of the second memory line;
responsive to determining that the size of the compressed write data is greater than the size of each memory block of the plurality of memory blocks of the second memory line, write the uncompressed write data to a plurality of the plurality of memory blocks of the second memory line; and
set a corresponding CI of each memory block of the plurality of memory blocks of the second memory line to indicate a compression status of each memory block of the plurality of memory blocks of the second memory line.

13. The CMC of claim 10, further comprising a compression monitor configured to track a compression ratio based on at least one of a number of reads of the compressed data, a total number of read operations, a number of writes of the compressed data, and a total number of write operations.

14. The CMC of claim 13, wherein the compression monitor is configured to track the compression ratio on one or more of a per-central processing unit (CPU) basis, a per-workload basis, a per-virtual-machine (VM) basis, a per-container basis, and on a per-Quality-of-Service (QoS)-identifier (QoSID) basis, as non-limiting examples.

15. The CMC of claim 13, wherein the compression monitor comprises one or more counters for tracking the at least one of the number of reads of the compressed data, the total number of the read operations, the number of writes of the compressed data, and the total number of the write operations.

16. The CMC of claim 13, further configured to:
responsive to receiving the memory read request, determine whether the compression ratio is below a threshold value; and
responsive to determining that the compression ratio is below the threshold value:
read the plurality of memory blocks of the first memory line;
determine, based on a CI of a first memory block of the plurality of memory blocks of the first memory line, whether the first memory block comprises the compressed data;
responsive to determining that the first memory block of the plurality of memory blocks comprises the compressed data:
decompress the compressed data of the first memory block into one or more decompressed memory blocks; and
identify a decompressed memory block of the one or more decompressed memory blocks containing the demand word; and
return the decompressed memory block; and
responsive to determining that the first memory block does not comprise the compressed data, return the plurality of memory blocks; and
the CMC configured to read the memory block indicated by the demand word indicator responsive to determining that the compression ratio equals or exceeds the threshold value.

17. A method for providing memory bandwidth compression, comprising:
receiving a memory read request comprising a physical address of a first memory line comprising a plurality of memory blocks in a system memory;
reading a first memory block of the plurality of memory blocks of the first memory line;
determining, based on a compression indicator (CI) of the first memory block, whether the first memory block comprises compressed data; and
responsive to determining that the first memory block does not comprise the compressed data:
performing a back-to-back read of one or more additional memory blocks of the plurality of memory blocks of the first memory line; and
in parallel with the back-to-back read:
determining whether a read memory block comprises a demand word; and
responsive to determining that the read memory block comprises the demand word, returning the read memory block.

18. The method of claim 17, further comprising, responsive to determining that the first memory block comprises the compressed data:
decompressing the compressed data of the first memory block into one or more decompressed memory blocks;
identifying a decompressed memory block among the one or more decompressed memory blocks comprising the demand word; and
returning the decompressed memory block comprising the demand word prior to returning the remaining one or more decompressed memory blocks.

19. The method of claim 17, further comprising:
receiving a memory write request comprising uncompressed write data and a physical address of a second memory line comprising a plurality of memory blocks in the system memory;
compressing the uncompressed write data into compressed write data;
determining whether a size of the compressed write data is greater than a size of each memory block of the plurality of memory blocks of the second memory line;
responsive to determining that the size of the compressed write data is not greater than the size of each memory block of the plurality of memory blocks of the second memory line, writing the compressed write data to a first memory block of the second memory line;
responsive to determining that the size of the compressed write data is greater than the size of each memory block of the plurality of memory blocks of the second memory line, writing the uncompressed write data to a plurality of the plurality of memory blocks of the second memory line; and
setting a CI of the first memory block of the plurality of memory blocks of the second memory line to indicate a compression status of the first memory block.

20. The method of claim 17, further comprising tracking, using a compression monitor, a compression ratio based on at least one of a number of reads of the compressed data, a total number of read operations, a number of writes of the compressed data, and a total number of write operations.

21. The method of claim 20, wherein the compression monitor comprises one or more counters for tracking the at least one of the number of reads of the compressed data, the total number of the read operations, the number of writes of the compressed data, and the total number of the write operations.

22. The method of claim 20, further comprising:
responsive to receiving the memory read request, determining whether the compression ratio is below a threshold value; and
responsive to determining that the compression ratio is below the threshold value:
reading the plurality of memory blocks of the first memory line;
determining, based on the CI of the first memory block of the plurality of memory blocks of the first memory line, whether the first memory block comprises the compressed data;
responsive to determining that the first memory block comprises the compressed data:
decompressing the compressed data of the first memory block into one or more decompressed memory blocks;
identifying a decompressed memory block of the one or more decompressed memory blocks containing the demand word; and
returning the decompressed memory block; and
responsive to determining that the first memory block does not comprise the compressed data, returning the plurality of memory blocks; and
wherein reading the first memory block of the plurality of memory blocks of the first memory line is responsive to determining that the compression ratio equals or exceeds the threshold value.

23. A method for providing memory bandwidth compression, comprising:
receiving a memory read request comprising:
a physical address of a first memory line comprising a plurality of memory blocks in a system memory; and
a demand word indicator indicating a memory block among the plurality of memory blocks of the first memory line containing a demand word;
reading the memory block indicated by the demand word indicator;
determining, based on a compression indicator (CI) of the memory block, whether the memory block comprises compressed data; and
responsive to determining that the memory block does not comprise the compressed data, performing a back-to-back read of one or more additional memory blocks of the plurality of memory blocks of the first memory line in parallel with returning the memory block.

24. The method of claim 23, further comprising, responsive to determining that the memory block comprises the compressed data:
decompressing the compressed data of the memory block into one or more decompressed memory blocks;
identifying a decompressed memory block of the one or more decompressed memory blocks containing the demand word; and
returning the decompressed memory block.

25. The method of claim 23, further comprising:
receiving a memory write request comprising uncompressed write data and a physical address of a second memory line comprising a plurality of memory blocks in the system memory;
compressing the uncompressed write data into compressed write data;
determining whether a size of the compressed write data is greater than a size of each memory block of the plurality of memory blocks of the second memory line;
responsive to determining that the size of the compressed write data is not greater than the size of each memory block of the plurality of memory blocks of the second memory line, writing the compressed write data to each memory block of the plurality of memory blocks of the second memory line;
responsive to determining that the size of the compressed write data is greater than the size of each memory block of the plurality of memory blocks of the second memory line, writing the uncompressed write data to a plurality of the plurality of memory blocks of the second memory line; and
setting a CI of each memory block of the plurality of memory blocks of the second memory line to indicate a compression status of each memory block of the plurality of memory blocks of the second memory line.

26. The method of claim 23, further comprising tracking, using a compression monitor, a compression ratio based on at least one of a number of reads of the compressed data, a total number of read operations, a number of writes of the compressed data, and a total number of write operations.

27. The method of claim 26, wherein tracking the compression ratio using the compression monitor comprises tracking on one or more of a per-central processing unit (CPU) basis, a per-workload basis, a per-virtual-machine (VM) basis, a per-container basis, and on a per-Quality-of-Service (QoS)-identifier (QoSID) basis, as non-limiting examples.

28. The method of claim 26, wherein the compression monitor comprises one or more counters for tracking the at least one of the number of reads of the compressed data, the total number of the read operations, the number of writes of the compressed data, and the total number of the write operations.

29. The method of claim 26, further comprising:
responsive to receiving the memory read request, determining whether the compression ratio is below a threshold value; and
responsive to determining that the compression ratio is below the threshold value:
reading the plurality of memory blocks of the first memory line;
determining, based on a CI of a first memory block of the plurality of memory blocks of the first memory line, whether the first memory block comprises the compressed data;
responsive to determining that the first memory block of the plurality of memory blocks comprises the compressed data:
decompressing the compressed data of the first memory block into one or more decompressed memory blocks; and
identifying a decompressed memory block of the one or more decompressed memory blocks containing the demand word; and
returning the decompressed memory block; and
responsive to determining that the first memory block does not comprise the compressed data, returning the plurality of memory blocks; and
wherein reading the memory block indicated by the demand word indicator is responsive to determining that the compression ratio equals or exceeds the threshold value.
